(19) United States
(12) Patent Application Publication
(10) Pub. No.: US 2025/0117173 A1
(43) Pub. Date: Apr. 10, 2025

(54) WORKFLOW SYSTEM, AND METHOD

(71) Applicant: CANON KABUSHIKI KAISHA, Tokyo (JP)

(72) Inventor: TAKAYUKI TSURUTA, Chiba (JP)

(21) Appl. No.: 18/901,496

(22) Filed: Sep. 30, 2024

(30) Foreign Application Priority Data
Oct. 4, 2023 (JP) 2023-173214

(51) Int. Cl. G06F 3/12; H04N 1/00; H04N 1/21

(52) U.S. Cl. CPC G06F 3/1275; G06F 3/1203; G06F 3/1237; G06F 3/1287; H04N 1/00212; H04N 1/2166

(57) ABSTRACT

A workflow system configured to execute a workflow comprising a workflow platform that is a service configured to enable a user to construct a workflow and a chat service that is a service configured to accept input from a user and perform notifications to a user wherein the workflow platform comprises a workflow construction unit configured to construct a workflow in cooperation with the chat service and a workflow execution unit configured to execute a workflow constructed by the workflow construction unit wherein the workflow construction unit is configured to be capable of constructing a workflow using input accepted by the chat service.

### BACKGROUND OF THE INVENTION

### Field of the Invention

The present invention relates to a workflow system, a method, and the like.

### Description of the Related Art

In recent years, the use of chat services and cloud services has been increasing. For example, there exist workflow platforms in which users themselves can construct workflows that combine various in-house services or various external online services from a chat service, and automate tasks. In addition, the above-described workflow platforms also provide units that enable users or third-party developers to add external online services.

In contrast, printing with a printer is also being performed by cooperating with workflows. Japanese Patent Laid-Open No. 2020-042436 discloses a method that provides a user interface for process settings and process parameter settings that are easily configurable by users when generating workflows.

However, in Japanese Patent Laid-Open No. 2020-042436, the workflow system assumes the operation of printers, and does not consider workflow platforms that can combine various online services to construct workflows.

Furthermore, constructing workflows that have scanning or posts from chat applications as constituent elements serving as image data input units is not considered. Therefore, conventionally, there was room for improvement in constructing user-friendly workflows.

### SUMMARY OF THE INVENTION

A workflow system according to one embodiment of the present invention is a workflow system configured to execute a workflow, comprising a workflow platform that is a service configured to enable a user to construct a workflow and a chat service that is a service configured to accept input from a user and perform notifications to a user wherein the workflow platform comprises a workflow construction unit configured to construct a workflow in cooperation with the chat service and a workflow execution unit configured to execute a workflow constructed by the workflow construction unit wherein the workflow construction unit is configured to be capable of constructing a workflow using input accepted by the chat service.

Further features of the present invention will become apparent from the following description of exemplary embodiments with reference to the attached drawings.

### BRIEF DESCRIPTION OF THE DRAWINGS

FIG. 1 is a diagram showing the overall configuration of a system according to a First Embodiment of the present invention.

FIG. 2 is a hardware configuration diagram of a printer according to the First Embodiment of the present invention.

FIG. 3 is a hardware configuration diagram of a client PC, workflow platform, and print service according to the First Embodiment of the present invention.

FIG. 4 is a software configuration diagram of a system according to the First Embodiment of the present invention.

FIG. 5 is a software configuration diagram of a system according to the First Embodiment of the present invention.

FIG. 6 is a software configuration diagram of a system according to the First Embodiment of the present invention.

FIG. 7 is a diagram showing a workflow list screen displayed on the chat service in the system according to the First Embodiment of the present invention.

FIG. 8 is a diagram showing a screen for setting a trigger of a workflow displayed on the chat service in the system according to the First Embodiment of the present invention.

FIG. 9 is a diagram showing a screen for setting actions of a workflow displayed on the chat service in the system according to the First Embodiment of the present invention.

FIG. 10 is a diagram showing a screen for setting the details of a workflow trigger or action displayed on the chat service in the system according to the First Embodiment of the present invention.

FIG. 11 is a diagram showing an example of a profile setting screen in the print service according to the First Embodiment of the present invention.

FIG. 12 is a flowchart showing an example of profile setting processing of the print service according to the First Embodiment of the present invention.

FIG. 13 is a flowchart of the workflow platform showing an example of processing of a file creation trigger according to the First Embodiment of the present invention.

FIG. 14 is a flowchart of the workflow platform showing an example of processing of a file creation action according to the First Embodiment of the present invention.

FIG. 15 is a flowchart of the workflow platform showing an example of processing of a redaction rule list acquisition action according to the First Embodiment, Second Embodiment, and Third Embodiment of the present invention.

FIG. 16 is a flowchart of the workflow platform showing an example of processing of an action to post a message and wait for a response according to the First Embodiment, Second Embodiment, and Third Embodiment of the present invention.

FIG. 17 is a flowchart of the workflow platform showing an example of processing of a redaction action according to the First Embodiment, Second Embodiment, and Third Embodiment of the present invention.

FIG. 18 is a flowchart of the workflow platform showing an example of processing of a file creation action according to the First Embodiment, Second Embodiment, and Third Embodiment of the present invention.

FIG. 19 is a flowchart of the workflow platform during workflow execution according to the First Embodiment of the present invention.

FIG. 20 is a flowchart showing an example of redaction processing of the print service during workflow execution according to the First Embodiment of the present invention.

FIG. 21 is a flowchart of the workflow platform showing an example of processing of a scan trigger according to the Second Embodiment of the present invention.

FIG. 22 is a flowchart of the workflow platform showing an example of processing of a profile addition request to the print service according to the Second Embodiment of the present invention.

FIG. 23 is a flowchart of the workflow platform showing an example of processing of a scan image data acquisition action according to the Second Embodiment of the present invention.

FIG. 24 is a flowchart of the workflow platform during workflow execution according to the Second Embodiment of the present invention.

FIG. 25 is a flowchart showing an example of scan processing of the print service during workflow execution according to the Second Embodiment of the present invention.

FIG. 26 is a flowchart of the workflow platform showing an example of processing of a message addition trigger according to a Third Embodiment of the present invention.

FIG. 27 is a flowchart of the workflow platform during workflow execution according to the Third Embodiment of the present invention.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

### <Overall Configuration>

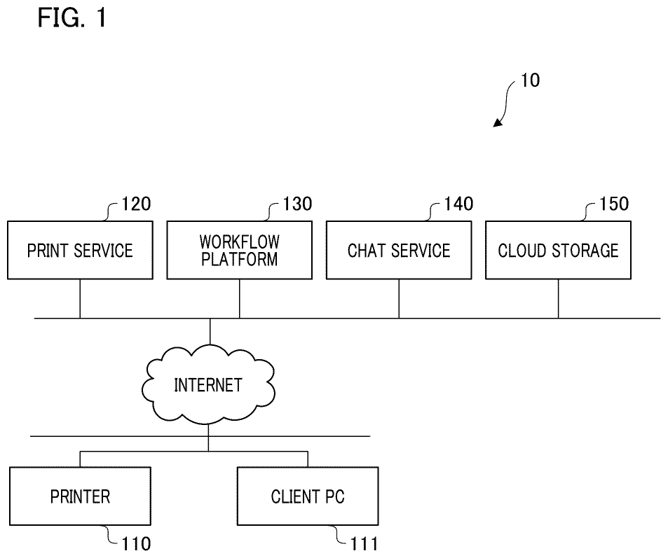

FIG. 1 is a diagram showing the overall configuration of a system according to a First Embodiment of the present invention. A workflow system 10 comprises a workflow platform 130, a print service 120, a chat service 140, a cloud storage 150, a printer 110, and a client PC 111.

PC is an abbreviation for “Personal Computer”. The workflow platform 130, the print service 120, and the chat service 140 may each be a separate computer, or at least one of these may be the same computer.

The workflow system 10 is an example of a print system. The workflow system 10 is an example of a scan system. The print service 120 and the chat service 140 are examples of online services.

The printer 110 and the client PC 111 are communicably connected via a LAN to servers that provide various services on the Internet. LAN is an abbreviation for “Local Area Network”.

The workflow platform 130 is a service configured to allow users to construct workflows. The workflow platform 130 is a service provided by an OS development company or the like, and can construct workflows by cooperating with services such as cloud storage and chat services provided by OS development companies or the like to build workflows. OS is an abbreviation for “Operating System”.

It should be noted that a workflow is data for executing individual processes, called “actions”, in a predetermined order. Actions are, for example, processes such as printing with the printer 110, hold printing with the printer 110, and scanning with the printer 110.

The process of scanning with the printer 110 is an example of a scan function. Processes related to printing, such as printing with the printer 110 and hold printing with the printer 110, may be referred to as print actions.

Processes related to scanning, such as scanning with the printer 110 and the like, may be referred to as scan actions. Actions are not limited to processes related to printing or scanning, and may be processes that do not relate to image processing devices such as the printer 110, such as approval requests, notification requests, file saving, conditional branching, and repetitive processing.

In addition, the workflow platform 130 includes a customization function that cooperates with online services provided by other companies. Thereby, according to the workflow platform 130, workflows cooperating with a variety of services can be created.

The print service 120 connects to the printer 110 and provides a service for receiving image data generated by scanning by using the printer 110. The print service 120 provides a service that transfers files to services capable of file storage such as storage services.

The print service 120 provides a service that sends files from storage services and the like, files from the client PC 111, and print jobs to the printer 110, and performs printing by using the printer 110. The print service 120 is an online service.

The chat service 140 is a communication service for performing chat. The chat service 140 cooperates with the workflow platform 130 and can perform notification to users through chat.

The chat service 140 is not limited to a service for performing chat, and may comprise functions for performing notification to users, such as mail, approval systems, or task management systems. In addition, these services that provide user notification functions may each be independent services.

The cloud storage 150 is a service in which files can be saved via the Internet and files can be acquired by using a web browser.

The client PC 111 is a client PC for performing display and operation with respect to each service that the workflow platform 130 comprises. Users can utilize each service through web browsers or applications operating on the client PC 111.

The printer 110 is a multifunction device comprising a plurality of functions such as a scanner and a printer, and is an example of an image processing apparatus.

Although the workflow system 10 of the present embodiment includes each of the above-described services, the present invention is not limited thereto and may have other configurations.

### <Hardware Configuration of the Printer>

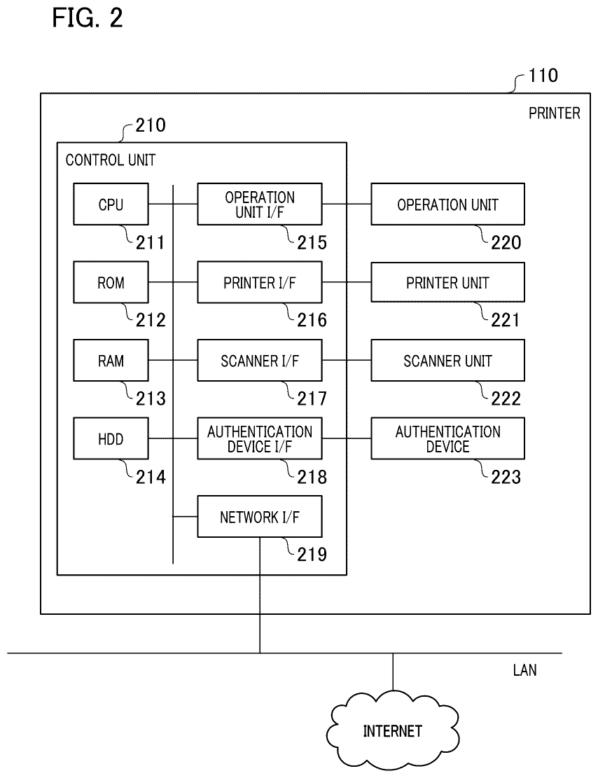

FIG. 2 is a hardware configuration diagram of the printer 110. The printer 110 comprises a control unit 210, an operation unit 220, a printer unit 221, a scanner unit 222, and an authentication device 223.

The control unit 210 controls the overall operation of the printer 110. The control unit 210 comprises a CPU 211, a ROM 212, a RAM 213, an HDD 214, an operation unit I/F 215, a printer I/F 216, a scanner I/F 217, an authentication device I/F 218, and a network I/F 219.

The CPU 211 realizes and controls various functions provided by the printer 110, such as reading/printing/communication, by reading and executing programs stored in the ROM 212 or the HDD 214. The ROM 212 is a non-volatile memory, and stores programs and data executed by the CPU 211. ROM is an abbreviation for “Read Only Memory”.

The RAM 213 is used as a temporary storage area such as the main memory of the CPU 211, work area, and the like. RAM is an abbreviation for “Random Access Memory”. The HDD 214 is a large-capacity storage unit that stores programs and data executed by the CPU 211. HDD is an abbreviation for “Hard Disk Drive”.

It should be noted that in the present embodiment, although one CPU 211 performs each process shown in the flowchart to be described below by using one memory (RAM 213 or HDD 214), the present invention is not limited thereto. For example, a plurality of CPUs or a plurality of RAMs or HDDs may cooperate to execute each process.

The operation unit I/F 215 is an interface that connects the operation unit 220 and the control unit 210. I/F is an abbreviation for “interface”. The operation unit 220 includes a touch panel, a keyboard, and the like, and accepts operations, inputs, and instructions by the user.

The printer I/F 216 is an interface that connects the printer unit 221 and the control unit 210. Image data for printing is transferred from the control unit 210 to the printer unit 221 via the printer I/F 216, and is printed on a recording medium.

The scanner I/F 217 is an interface that connects the scanner unit 222 and the control unit 210. The scanner unit 222 reads a document that is set on a document table (not shown) or an ADF to generate scanned image data, and outputs the generated image data to the control unit 210 via the scanner I/F 217. ADF is an abbreviation for “Auto Document Feeder”.

The printer 110 can print and output (copy) image data generated by the scanner unit 222 from the printer unit 221, as well as perform file transmission or mail transmission of image data.

The authentication device I/F 218 is an interface that connects the authentication device 223 and the control unit 210. The authentication device 223 is, for example, a card reader that reads IC cards, a fingerprint authentication device that reads fingerprints, and the like, and is used for authentication and the like for the user to use the printer 110.

The network I/F 219 is an interface that connects the control unit 210, that is, the printer 110, to a LAN. The printer 110 transmits and receives various types of information such as image data and information with various services on the Internet by using the network I/F 219.

### <Hardware Configuration of the Client PC, Workflow Platform, and Print Service>

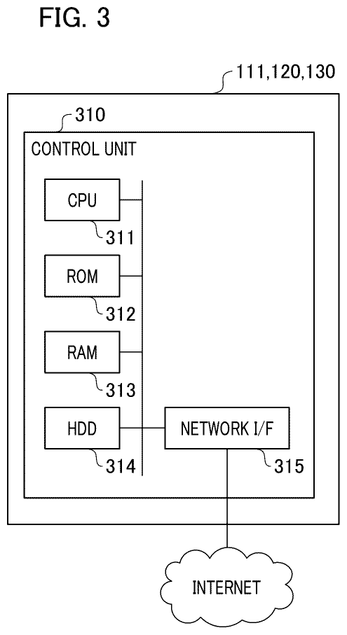

FIG. 3 is a hardware configuration diagram of each of the client PC 111, the print service 120, and the workflow platform 130.

Each of the client PC 111, the print service 120, and the workflow platform 130 comprises a control unit 310. The control unit 310 comprises a CPU 311, a ROM 312, a RAM 313, an HDD 314, and a network I/F 315.

The CPU 311 realizes various functions by reading and executing programs stored in the ROM 312 or HDD 314, and controls the overall operation. The ROM 312 is a non-volatile memory that stores programs and data executed by the CPU 311.

The RAM 313 is used as a temporary storage area such as the main memory of the CPU 311, a work area, and the like. The HDD 314 is a large-capacity storage unit that stores programs and data executed by the CPU 311.

In the HDD 314 of the client PC 111, application programs for using each service are stored, for example, a chat application for using the functions provided by the chat service 140 is stored.

The network I/F 315 is an interface that connects each of the client PC 111, the print service 120, and the workflow platform 130 to the Internet. The client PC 111, the print service 120, and the workflow platform 130 receive processing requests and transmit and receive various types of information with other devices and services via the network I/F 315.

### <Software Configuration of the Workflow System>

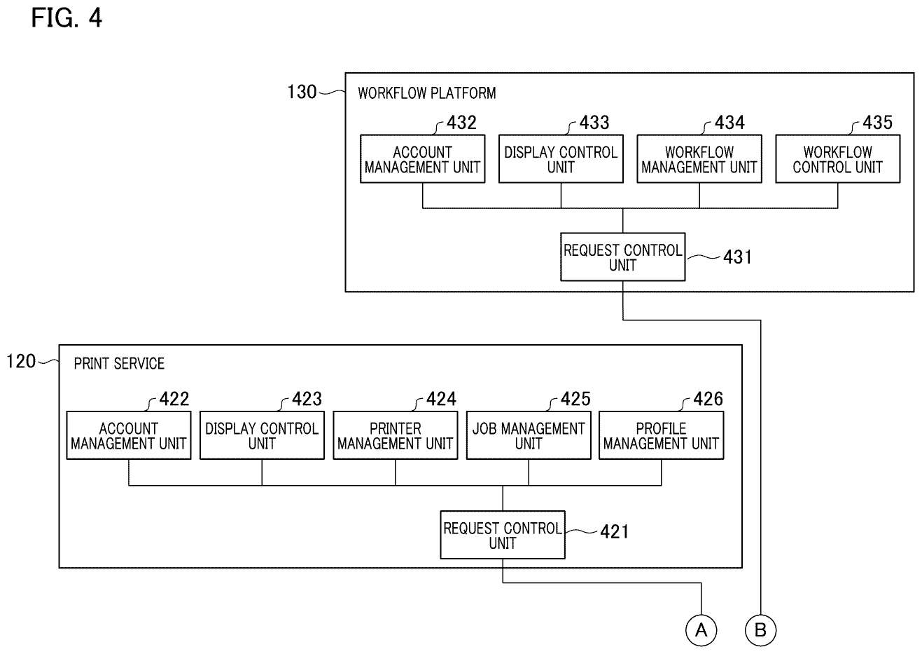

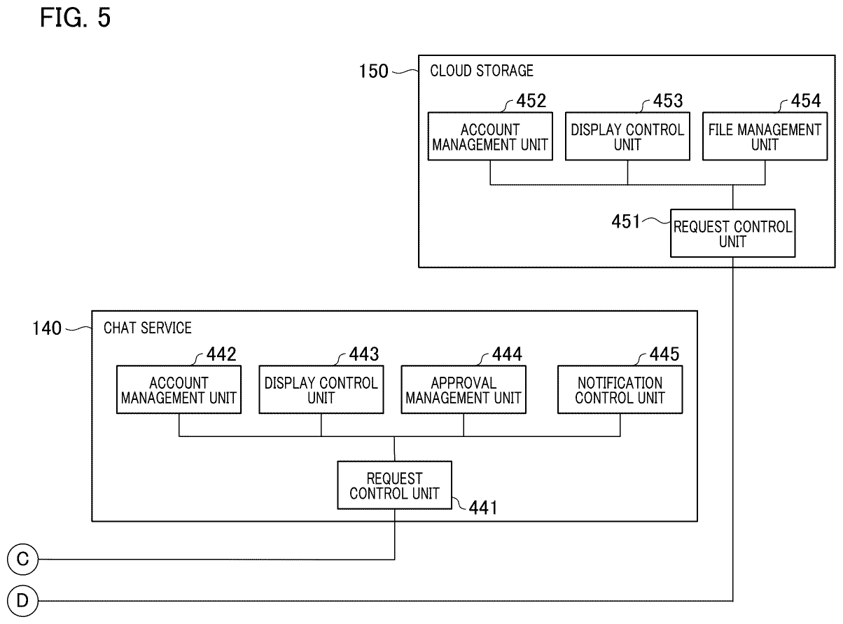

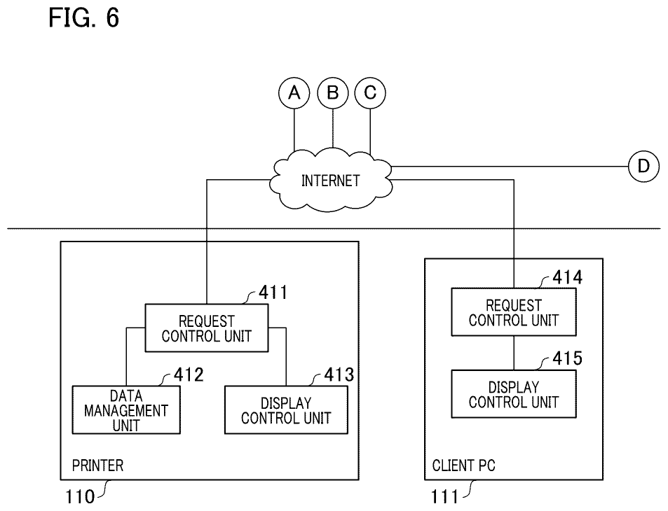

FIG. 4, FIG. 5, and FIG. 6 are software configuration diagrams of the workflow system 10 according to the present embodiment. The circled letters shown in FIG. 6 connect to the same letters among the circled letters shown in FIG. 6. In addition, the circled letters shown in FIG. 5 connect to the same letters among the circled letters shown in FIG. 6.

As shown in FIG. 4, the workflow platform 130 comprises a request control unit 431, an account management unit 432, a display control unit 433, a workflow management unit 434, and a workflow control unit 435.

The request control unit 431 is waiting in a state in which requests from the print service 120, the chat service 140, the cloud storage 150, the printer 110, and the client PC 111 can be received.

The account management unit 432 manages account information for logging into the workflow platform 130. It should be noted that in the present embodiment, the workflow platform 130 and other services each have separate account information.

The present embodiment is not limited to this, and a common account management service for each service may be separately prepared, enabling single sign-on to each service with the same account. For example, the accounts of the workflow platform 130 and the chat service 140 may be managed as the same account in the same account management unit.

The display control unit 433 returns screen configuration information necessary for screen display by receiving requests from a web browser operating on the client PC 111 connected via the Internet. The screen configuration information is HTML, CSS, and the like.

HTML is an abbreviation for “HyperText Markup Language”. CSS is an abbreviation for “Cascading Style Sheets”. The display control unit 433 can also return screen configuration information by receiving requests from a web browser operating on another terminal device such as a mobile terminal device.

The workflow management unit 434 creates workflows in the workflow platform 130 and performs management such as editing and saving of the workflows. The workflow control unit 435 controls the execution and stoppage of workflows saved in the workflow management unit 434 in response to workflow execution requests from the request control unit 431. This execution of the workflow is an example of the workflow execution unit.

As shown in FIG. 4, the print service 120 comprises a request control unit 421, an account management unit 422, a display control unit 423, a printer management unit 424, a job management unit 425, and a profile management unit 426. The request control unit 421 is waiting in a state in which requests from the printer 110 and the workflow platform 130 can be received.

The account management unit 422 manages account information for logging into the print service 120. In addition, the account information for logging into the print service 120 may be associated with user information used for logging into the printer 110.

The display control unit 423 returns screen configuration information necessary for screen display by receiving requests from a web browser operating on the client PC 111 connected via the Internet. The display control unit 423 can also return screen configuration information by receiving requests from a web browser operating on another terminal device such as a mobile terminal device.

The printer management unit 424 manages printers registered in the print service 424. The printer management unit 424 can also acquire the status, printing performance, scanning performance, and various settings of the registered printers.

The job management unit 425 receives and manages print and scan jobs from the workflow platform 130, the client PC 111, and the chat service 140. The job management unit 425 transmits the managed jobs to a printer registered in the print service 120 according to requests and executes the jobs.

The profile management unit 426 manages the document reading settings during scan execution and the storage destinations of the image files generated by scanning as profile information. Profile information can be created, edited, and deleted by receiving requests from the client PC 111 and the workflow platform 130.

As shown in FIG. 5, the chat service 140 comprises a request control unit 441, an account management unit 442, a display control unit 443, an approval management unit 444, and a notification control unit 445. The request control unit 441 is waiting in a state in which requests from the client PC 111, the print service 120, and the workflow platform 130 can be received.

The account management unit 442 manages account information for logging into the chat service 140. In addition, as described in the explanation of the account management unit 432, the accounts of the workflow platform 130 and the chat service 140 may be managed as the same account in the same account management unit.

The display control unit 443 returns the screen configuration information necessary for screen display by receiving requests from a chat application or web browser operating on the client PC 111 connected via the Internet. The display control unit 443 can also return screen configuration information by receiving requests from a web browser operating on another terminal device such as a mobile terminal device.

The approval management unit 444 receives approval requests from external services such as the chat service 140, the workflow platform 130, or the print service 120 and manages the approval requests and the approval status thereof for accounts on the chat service 140.

For example, a user of the chat service 140 can issue an approval request for a quotation to another user having an account on the chat service 140, and the account that received the approval request can process the approval or denial.

The notification control unit 445 receives notification requests from external services such as the chat service 140, the workflow platform 130, or the print service 120 and performs notifications to accounts on the chat service 140.

As shown in FIG. 5, the cloud storage 150 comprises a request control unit 451, an account management unit 452, a display control unit 453, and a file management unit 454. The request control unit 451 is waiting in a state in which requests from the client PC 111, the print service 120, and the workflow platform 130 can be received.

The account management unit 452 manages account information for logging into the cloud storage 150. In addition, the accounts of the workflow platform 130 and the cloud storage 150 may be managed as the same account in the same account management unit.

The display control unit 453 returns screen configuration information necessary for screen display by receiving requests from a web browser operating on the client PC 111 connected via the Internet. The display control unit 453 can also return screen configuration information by receiving requests from a web browser operating on another terminal device such as a mobile terminal device.

The file management unit 454 manages files saved in the cloud storage 150 and performs saving, modification, deletion, transmission, and the like according to requests.

As shown in FIG. 6, the printer 110 comprises a request control unit 411, a data management unit 412, and a display control unit 413. The request control unit 411 is waiting in a state in which processing requests from the print service 120 can be received. The printer 110, upon receiving a processing request, instructs the display control unit 413 and the workflow management unit 434 to perform processing according to the request as appropriate.

The data management unit 412 manages user information, connection information with the print service 120, and the like. The display control unit 413 displays a UI screen on a liquid crystal display unit, which has touch panel functionality, of the operation unit 220 of the printer 110 for receiving operations by the user.

It should be noted that although FIG. 4, FIG. 5, and FIG. 6 disclose only one printer 110 connected to the print service 120, the workflow system 10 may have a plurality of printers connected to the print service 120.

In addition, in a case in which the printer 110 is registered with the print service 120, the printer 110 performs communication with the print service 120 constantly or periodically so that the printer 110 can receive requests from the print service 120.

As shown in FIG. 6, the client PC 111 comprises a request control unit 414 and a display control unit 415. The client PC 111 accesses the print service 120, the workflow platform 130, the chat service 140, and the cloud storage 150 via the request control unit 414.

The user operates the workflow platform 130 and various online services via the screen displayed in the web browser displayed by the display control unit 415 of the client PC 111.

### <Processing Flow>

First, the steps for constructing a workflow on the workflow platform 130 will be explained. These steps are an example of a workflow construction unit that is configured to construct workflows.

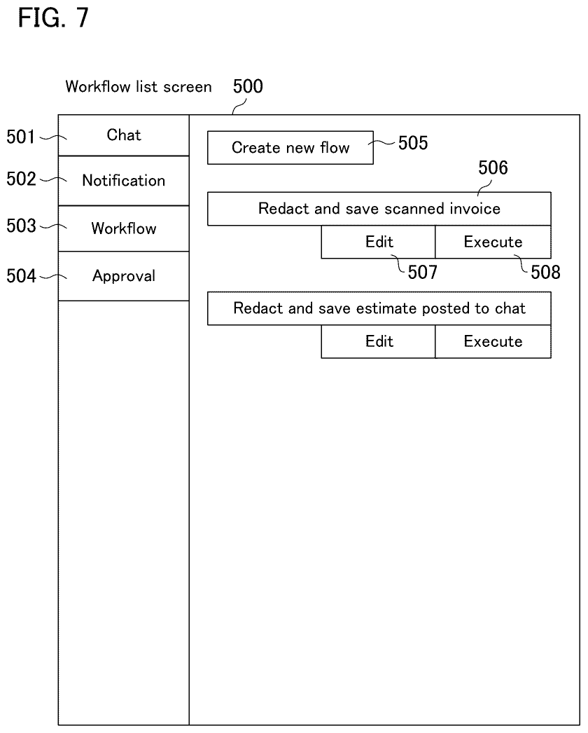

FIG. 7 is a diagram showing a workflow list screen that is displayed on the chat service in the system according to the First Embodiment of the present invention. The chat service 140 cooperates with the workflow platform 130 by being authenticated with the account of the workflow platform 130.

The client PC 111 acquires the configuration information of a workflow list screen 500 from the display control unit 443 of the chat service 140 and displays this configuration information via the chat application on the display control unit 415. It should be noted that, as described previously, the account of the chat service 140 may be the same as the account of the workflow platform 130, and in that case, authentication for cooperation is unnecessary.

The workflow list screen 500 is configured to be divided into a sidebar and a main screen. The workflow list screen 500 displays a button 501 for transitioning to the chat screen, a button 502 for transitioning to the notification screen, a button 503 for transitioning to the workflow list screen, and a button 504 for transitioning to the approval screen in the sidebar.

The workflow list screen 500 displays on the main screen a button 505 for creating a new workflow, a section 506 for displaying the titles of created workflows, a button 507 for performing editing of workflows, and a button 508 for executing workflows.

When transitioning from the workflow list screen 500 to the chat screen, notification screen, or approval screen, the display on the sidebar is not changed, and only the display on the main screen is changed. The workflow list screen 500 is displayed when the user presses the button 503.

Workflows can be created, edited, or executed from the workflow list screen 500. It should be noted that for some workflows, the start conditions of the workflow are created to be executed by, for example, a specific date and time or a specific action. In that case, when the button 508 is pressed, it is also possible to manually set and execute the content of the specific action that is the condition.

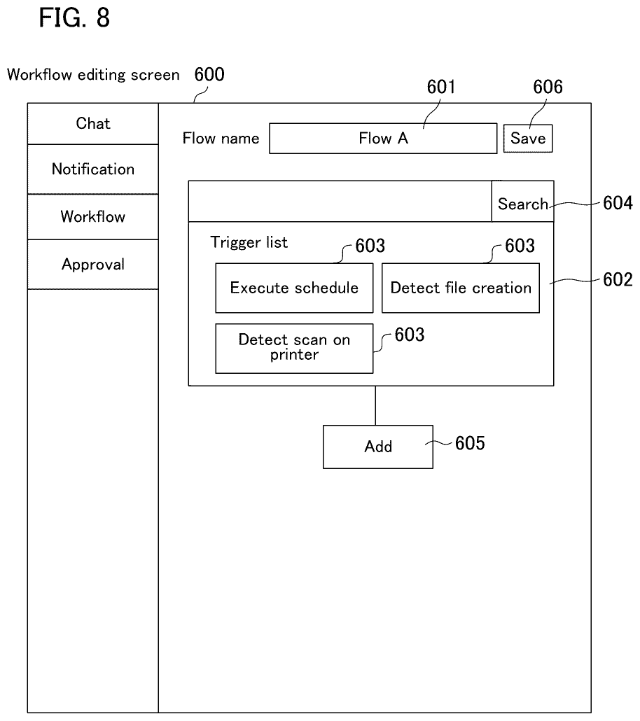

FIG. 8 is a diagram showing an example of a workflow editing screen 600 displayed when the button 505 for creating a new workflow is pressed. FIG. 8 is a diagram showing a screen for setting a workflow trigger displayed on the chat service in the system according to the First Embodiment of the present invention. The workflow editing screen 600 is an example of a screen for setting a trigger of a workflow.

The workflow editing screen 600 is configured by being divided into two parts, a sidebar and a main screen, similar to the workflow list screen 500. The main screen of the workflow editing screen 600 has a box 601 for editing the workflow name, a workflow trigger list screen 602, and a button 603 for selecting a trigger of the workflow.

The main screen of the workflow editing screen 600 has a button 604 for searching for triggers of the workflow, a button 605 for adding actions of the workflow, and a button 606 for saving the workflow.

In the workflow platform 130, workflows are constructed by combining triggers, which are execution conditions of the workflow, and actions, which are the processing content of the workflow. Because the start of a workflow must always be a trigger, the workflow editing screen 600 sets the trigger before the action.

The workflow trigger list screen 602 displays a list of usable triggers of the workflow platform 130. Triggers are, for example, a schedule trigger that starts the workflow periodically, a file trigger that is executed when any cloud storage is updated, a scan trigger that is executed when scanning is started on a printer, and the like.

These are merely examples, and the actions provided by the workflow platform 130 and other external services are not limited to these examples.

When the button 603 is pressed, in a case in which the account logged into the workflow platform 130 has already established cooperation with the external service that provides that trigger, the trigger setting screen is displayed. In a case in which cooperation has not been established, an authentication screen for performing cooperation is displayed, and after authentication, the trigger setting screen is displayed.

The button 604 is for searching the workflow triggers displayed on the workflow trigger list screen 602, and can search for triggers using the input character string. This search targets triggers of the workflow platform 130 itself, triggers of other external services, and triggers of the print service.

For example, if a search is performed by inputting the character string “save”, a list of triggers related to saving, such as actions that trigger when data is saved to the cloud storage 150, is displayed. Similarly, by searching for “scan”, a list of triggers that start the workflow when the print service 120 performs scanning is displayed.

The trigger to start the execution of the workflow is determined by the user selecting the action that the user wants to use in the workflow from these search results.

When the button 605 is pressed, a workflow action addition screen is displayed. When button 606 is pressed, the created workflow is saved.

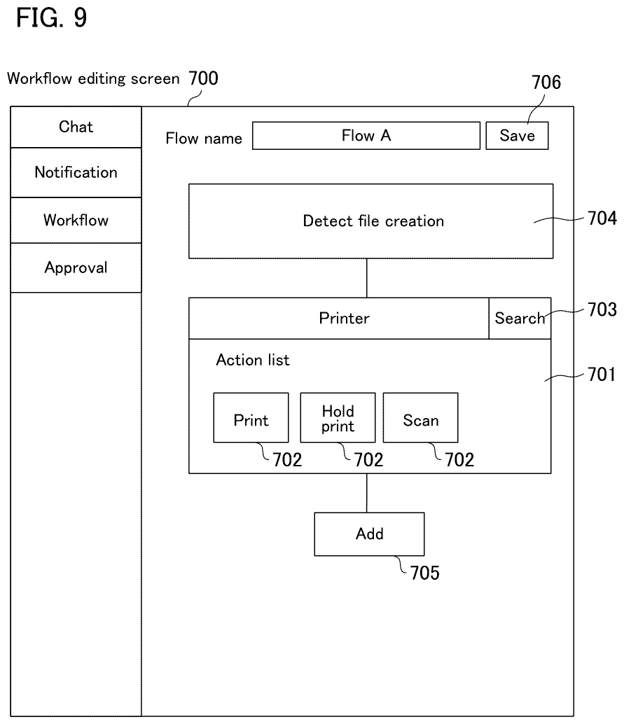

FIG. 9 is a diagram showing an example of a workflow editing screen 700 displayed when the button 605 is pressed. FIG. 9 is a diagram showing a screen for setting the actions of the workflow displayed on the chat service in the system according to the First Embodiment of the present invention.

A workflow action corresponds to one process of the workflow, and performs some kind of transmission or reception to an external service, or performs control processing of the workflow itself such as waiting, branching, or repeating of the workflow.

The main screen of the workflow editing screen 700 includes a workflow action list screen 701, a button 702 for selecting actions of the workflow, and a button 703 for searching for actions of the workflow.

The main screen of the workflow editing screen 700 includes a button 704 that displays the name of the set trigger and displays the trigger editing screen when pressed. The main screen of the workflow editing screen 700 has a button 705 for adding actions of the workflow and a button 706 for saving the workflow.

The workflow action list screen 701 displays a list of usable actions of the workflow platform 130. Actions are, for example, a print action that starts printing on a printer, a hold print action that performs hold printing on a printer, and a scan action that starts scanning on a printer.

These are merely examples, and actions may not involve printers, for example, approval requests, notification requests, redaction processing on image data, file saving, and conditional branching or repetitive processing are also included in actions.

Redaction processing is, for example, a process that makes the character string unreadable by filling the corresponding character string in a file with black color. In addition, the actions provided by the workflow platform 130 and other external services are not limited to these examples.

When the button 702 is pressed, in a case in which the account logged into the workflow platform 130 is already cooperating with the external service that provides that action, the action setting screen is displayed. In a case in which the account is not cooperating, an authentication screen for performing cooperation is displayed, and after authentication, the action setting screen is displayed.

The button 703 is for searching the workflow actions that are displayed on the workflow action list screen 701, and can search for actions with the input character string. This search targets actions of the workflow platform 130 itself, actions of other external services, and actions of the print service 120.

For example, if a search is performed by the input of the character string “notification”, actions for the chat service 140 to notify any user or group are displayed. Alternatively, if a search is performed by the input of the character string “save”, a list of actions related to saving, such as saving data to the cloud storage 150, is displayed.

Similarly, by searching for “print,” a list of actions of connectors that perform printing by the print service 120 is displayed. The action of the workflow is determined when the user selects an action that the user wants to use in the workflow from these search results.

The button 704 displays the name of the set trigger. When the button 704 is pressed, the editing screen of the trigger is displayed.

When the button 705 is pressed, a new workflow action list screen 701 is displayed below the already displayed workflow action list screen 701. Accordingly, it is possible to create a workflow that combines a plurality of workflow actions. When the button 706 is pressed, the created workflow is saved.

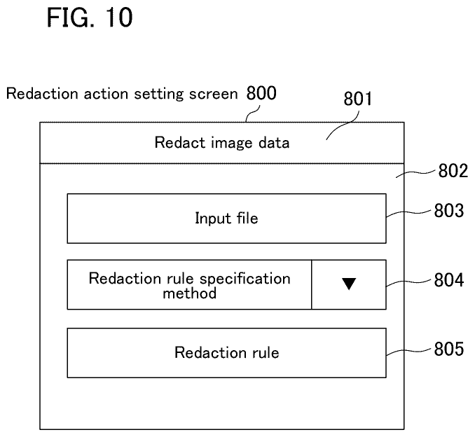

FIG. 10 is a diagram showing a screen for performing setting of workflow actions and workflow triggers. FIG. 10 is a diagram showing a screen for setting the details of a workflow trigger or action that is displayed on the chat service in the system according to the First Embodiment of the present invention. Here, as an example, a workflow action setting screen 800 for applying redaction processing on image data is shown.

The workflow action setting screen 800 comprises a field 801 for displaying the action name and an action setting list 802. The action setting list 802 comprises action settings 803, 804, and 805.

The action settings 803, 804, and 805 are examples of settings for the redaction action. These action settings accept input by methods such as free text input, selection from options, and using values acquired in previous or subsequent workflows.

In addition, candidates for options in the action settings can be acquired from external services and displayed. Moreover, these settings are not limited to action settings but are also similarly applicable to trigger settings.

The field 801 displays the name of the action. In addition, the name displayed in field 801 may be made freely changeable by the user. The workflow action setting screen 800 sets the workflow action of the action name of field 801 according to the content specified in each action setting of the action setting list 802.

The action setting 803 accepts the specification of the target file to perform redaction processing. Here, the specification method specifies the file acquired by a workflow trigger or workflow action executed prior to the redaction action, or specifies a URL or identifier indicating that file.

In addition, the specification method in the action setting 80 is, for example, to specify a file acquired from cloud storage 150. URL is an abbreviation for “Uniform Resource Locator”.

The action setting 804 accepts the selection of the specification method for the redaction rules to be performed on the target image data. Here, a redaction rule is something that defines the locations at which redaction processing is to be applied in the image data. For example, the redaction rule may select a rule predefined in an external service that provides redaction processing.

The redaction rule may, for example, specify keywords such as “email address”, “phone number”, or “address”. The redaction rule may, for example, have the user specifically input character strings or formats they want to redact.

The redaction rule may, for example, be specified by an identifier of a redaction rule acquired by a trigger or action executed before this action. The action setting 804 is a component that accepts user selection of these redaction rule specification methods, and is selected from specification methods such as “User-defined”, “Keyword”, or “Free description”.

The action setting 805 displays a component according to the redaction rule specification method selected in the action setting 804. For example, in a case in which “User-defined” is selected in action setting 804, the workflow platform 130 displays a list of redaction rules already defined in the external service that provides redaction processing as the action setting 805.

In addition, in a case in which “keyword” or “free text” is selected in the action setting 804, the workflow platform 130 displays, as the action setting 805, a text box into which the user can freely input text. It should be noted that what is shown here are just examples, and the specification method of redaction locations is not limited to these examples.

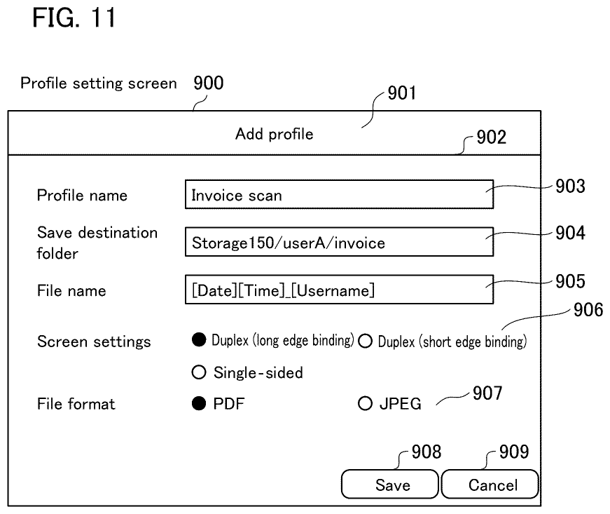

FIG. 11 is a diagram showing an example of a profile setting screen 900 in the print service 120. Here, a profile is a scan rule defined in the print service 120, and by defining this scan rule, the printer 110 under the management of the print service 120 can execute scanning by selecting the profile.

The profile setting screen 900 comprises a title display region 901 and a profile setting region 902. The profile setting region 902 comprises a profile name setting 903, a save destination folder setting 904, a file naming rule setting 905, a duplex setting 906, a file format setting 907, a save button 908, and a cancel button 909.

The profile name setting 903 accepts input of the profile name currently being set.

The save destination folder setting 904 accepts the designation of the save destination for image data generated by scanning by the printer. The save destination folder setting 904 can, for example, specify a folder within the cloud storage 150.

The file naming rule setting 905 accepts specification of the naming rule for the file name of image data generated by scanning. The naming rule can be configured from static character strings and dynamic character strings such as the date and time of scan execution or the name of the user who executed the scan.

The duplex setting 906 accepts the specification of the duplex setting during scan execution in the printer 110.

The file format setting 907 accepts the specification of the file format of the image data generated by scanning.

The setting items shown in FIG. 11 are examples, and there may be other settings related to scanning processes, such as the presence or absence of character extraction processing by OCR or access restrictions for the save destination folder. OCR is an abbreviation for “Optical Character Recognition”.

With the save button 908 and the cancel button 909, the user can select whether or not to save the profile. In a case in which the save button 908 is pressed, the set profile information is managed by the profile management unit 426 in the print service 120. For profiles managed by the profile management unit 426, it is possible to display a list on a profile list screen (not shown), select profiles to be edited, and delete profiles.

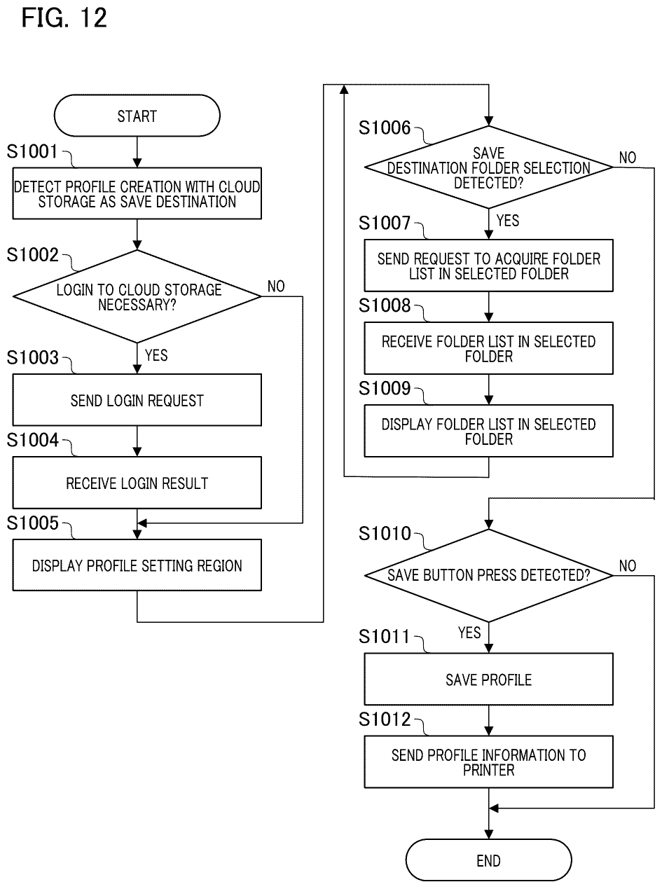

Next, the procedure for actually connecting to each service and configuring settings to construct a workflow will be explained with respective flowcharts. FIG. 12 is a flowchart showing an example of processing for constructing a profile that stores image data generated by scanning on the printer 110 in the cloud storage 150 in the print service 120 in the present system.

The print service 120 executes the processing of FIG. 12 in cooperation with the cloud storage 150. FIG. 12 is a flowchart showing an example of profile setting processing of the print service according to the First Embodiment of the present invention.

In step S1001, the print service 120 detects a profile addition request with the cloud storage 150 as the send destination. The profile addition request is, for example, sent to the print service 120 by the user operating a dedicated application for the print service or a web browser on the client PC 111.

In step S1002, the print service 120 confirms whether or not cooperation with the cloud storage 150 has already been set up, and determines whether login to the cloud storage 150 is necessary. In a case in which the print service 120 determines that login to the cloud storage 150 is necessary, the processing of step S1003 is executed.

In a case in which the print service 120 determines that login to the cloud storage 150 is not necessary, the processing of step S1005 is executed.

In step S1003, the print service 120 sends a login request to the cloud storage 150.

In step S1004, the print service 120 receives the login result from the cloud storage 150, and thereafter can communicate with the cloud storage 150 as having established cooperation.

In step S1005, the print service 120 displays the profile setting screen 900 and accepts profile setting input by the user.

In step S1006, the print service 120 determines whether or not the print service 120 has detected the selection of a save destination folder by a user. In a case in which the print service 120 determines that the print service 120 has detected the selection of a save destination folder, the processing of step S1007 is executed. In a case in which the print service 120 determines that the print service 120 has not detected the selection of a save destination folder, the processing of step S1010 is executed.

In step S1007, the print service 120 transmits a request to the cloud storage 150 to acquire a list of folders in the cloud storage selected by the user.

In step S1008, the print service 120 receives the folder list of the cloud storage 150.

In step S1009, the print service 120 displays the folder list received in step S1008 in the save destination folder setting 904. At this time, in a case in which folder selection is detected for the first time, information under the highest-level folder selectable by the logged-in user is acquired. Then, the processing of step S1006 is executed.

In step S1010, the print service 120 determines whether or not the pressing of the save button 908 has been detected. In a case in which the print service 120 determines that the pressing of the save button 908 has been detected, the processing of step S1011 is executed. In a case in which the print service 120 determines that the pressing of the save button 908 has not been detected, the processing is terminated.

In step S1011, the print service 120 saves the setting information in the profile management unit 426.

In step S1012, the print service 120 transmits the profile information to the printer 110 that is connected to the print service 120.

By the processing of steps S1001 to S1012 described above, the profile becomes selectable on the operation unit 220 of the printer 110. In addition, thereafter, by selecting the profile and performing a scan operation, the scanned image data can be stored in a specified folder of the cloud storage 150.

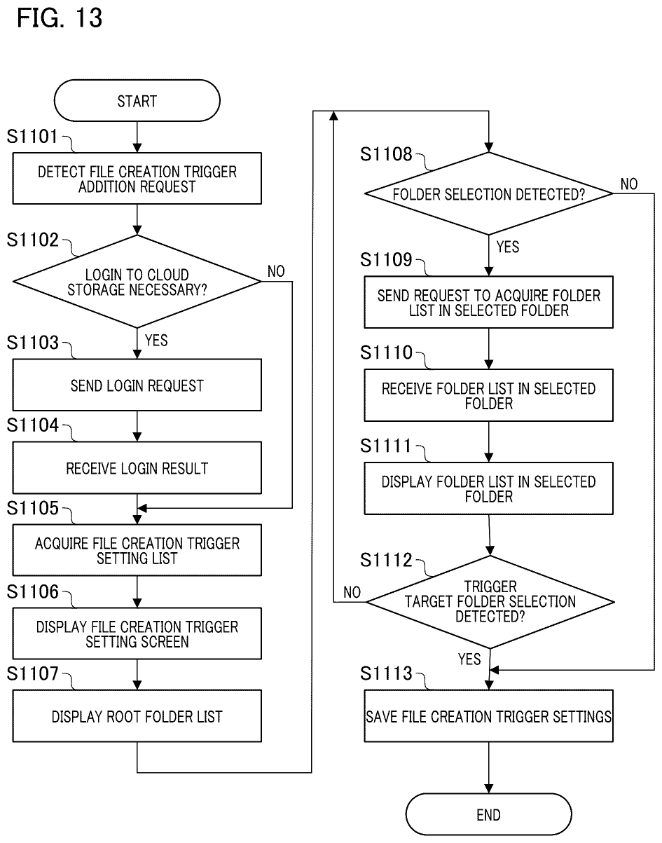

Next, the procedure for actually connecting to each service and configuring settings to construct a workflow will be explained with respective flowcharts. FIG. 13 is a flowchart showing details when performing the construction of a workflow in cooperation with the cloud storage 150 in the workflow platform 130 in the present system.

FIG. 13 is a flowchart of the workflow platform showing an example of processing of a file creation trigger according to the First Embodiment of the present invention. In the Present Embodiment, as an example thereof, a file creation trigger that starts a workflow when a file is created is constructed as a workflow trigger.

In step S1101, the workflow platform 130 detects a request to add a file creation trigger.

In step S1102, the workflow platform 130 confirms whether cooperation with the cloud storage 150 that provides the file creation trigger has already been set up, and determines whether login to the cloud storage 150 is necessary.

In a case in which the workflow platform 130 determines that login to the cloud storage 150 is necessary, the processing of step S1103 is executed. In a case in which the workflow platform 130 determines that login to the cloud storage 150 is not necessary, the processing of step S1105 is executed.

In step S1103, the workflow platform 130 transmits a login request to the cloud storage 150.

In step S1104, the workflow platform 130 receives the login result from the cloud storage 150. Thereafter, the workflow platform 130 can communicate with the cloud storage 150 as having established cooperation.

In step S1105, the workflow platform 130 acquires a list of file creation trigger settings.

In step S1106, the workflow platform 130 displays the list of file creation trigger settings acquired in step S1105. It should be noted that for each setting, options acquired from an external service can be displayed, in this case the cloud storage 150 with which the workflow platform cooperates.

For the file creation trigger, it is necessary to set in which folder the file creation triggers execution. In step S1107, the workflow platform 130 first displays a list of root folders of the cloud storage 150.

In step S1108, the workflow platform 130 determines whether or not the workflow platform 130 has detected that any folder has been selected from the list. In a case in which the workflow platform 130 determines that the workflow platform 130 has detected a folder selection, the processing of step S1109 is executed. In a case in which the workflow platform 130 determines that the workflow platform 130 has not detected a folder selection, the processing of step S1113 is executed.

In step S1109, the workflow platform 130 transmits a request to acquire a list of folders within the selected folder.

In step S1110, the workflow platform 130 receives the folder list acquisition result.

In step S1111, the workflow platform 130 displays the folder list received in step S1110.

In step S1112, the workflow platform 130 determines whether the selection of a folder to be the trigger target has been detected. In a case in which the workflow platform 130 determines that the workflow platform 130 has detected the trigger target folder selection, the processing of step S1113 is executed.

In a case in which the workflow platform 130 determines that the workflow platform 130 has not detected the selection of a trigger target folder, the processing of step S1108 is executed.

In step S1113, the workflow platform 130 saves the settings of the file creation trigger.

According to the steps of FIG. 13, the workflow platform 130 can incorporate the file creation trigger into any workflow. It should be noted that the file creation trigger provides acquisition of metadata such as the name of the created file, ID, time, folder path, and the like, with respect to the created file, in workflow actions implemented after this trigger.

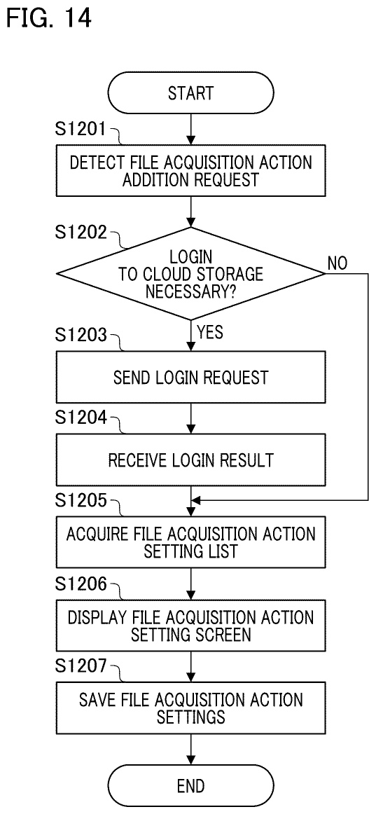

In a case in which the folder that is the target of the trigger matches the save destination of the profile in the print service 120, the trigger incorporated by the steps of FIG. 14 is activated in conjunction with the scan operation of the user on the printer 110.

FIG. 14 is a flowchart showing details of when performing the construction of a workflow in cooperation with the cloud storage 150 in the workflow platform 130 in the present system. FIG. 14 is a flowchart of the workflow platform showing an example of processing of a file creation action according to the First Embodiment of the present invention.

In the Present Embodiment, as an example thereof, a file acquisition action to acquire files from the cloud storage 150 is constructed as a workflow action. The file acquisition action is an action to acquire the content of a specified file, a publicly available URL, or a limited-access URL.

In step S1201, the workflow platform 130 detects a request to add a file acquisition action.

In step S1202, the workflow platform 130 confirms whether cooperation with the cloud storage 150 that provides the file acquisition action has already been set up, and determines whether login to the cloud storage 150 is necessary.

In a case in which the workflow platform 130 determines that login to the cloud storage 150 is necessary, the processing of step S1203 is executed. In a case in which the workflow platform 130 determines that login to the cloud storage 150 is not necessary, the processing of step S1205 is executed. For example, in a case in which the processing of the flowchart shown in FIG. 11 has already been executed, login is unnecessary because cooperation has already been established.

In step S1203, the workflow platform 130 transmits a login request to the cloud storage 150.

In step S1204, the workflow platform 130 receives the login result from the cloud storage 150. Thereafter, the workflow platform 130 can communicate with the cloud storage 150 as having established cooperation.

In step S1205, the workflow platform 130 acquires a list of settings of the file acquisition action.

In step S1206, the workflow platform 130 displays the setting screen for the file acquisition action acquired in step S1205. In the file acquisition action, it is necessary to set the target file to be acquired.

For example, the workflow is constructed so that the target file to be acquired can be specified from the file path that can be acquired as the execution result of the file creation trigger in FIG. 11, and values that can be obtained from other triggers and actions.

In step S1207, the workflow platform 130 saves the settings of the set file acquisition action.

According to the steps of FIG. 14, the workflow platform 130 can incorporate the file acquisition action into any workflow.

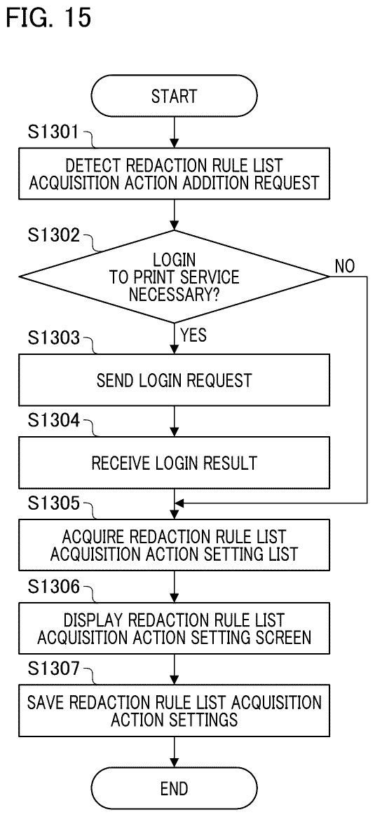

FIG. 15 is a flowchart showing details when performing the construction of a workflow in cooperation with the print service 120 in the workflow platform 130 in the present system. FIG. 15 is a flowchart of the workflow platform showing an example of processing of a redaction rule list acquisition action according to the First Embodiment, Second Embodiment, and Third Embodiment of the present invention.

In the Present Embodiment, as an example thereof, assuming that the print service 120 provides redaction processing, a process to acquire a list of redaction rules already defined in the print service 120 is constructed as a workflow action. This workflow action is an action to acquire list information configured by the names, identifiers, and the like, of redaction rules defined in the print service 120.

In step S1301, the workflow platform 130 detects an addition request of the redaction rule list acquisition action.

In step S1302, the workflow platform 130 confirms whether cooperation with the print service 120 that provides the redaction rule list acquisition action is already set, and determines whether login to the print service 120 is necessary.

In a case in which the workflow platform 130 determines that login to the print service 120 is necessary, the processing of step S1303 is executed. In a case in which the workflow platform 130 determines that login to the print service 120 is not necessary, the processing of step S1305 is executed.

In step S1303, the workflow platform 130 transmits a login request to the print service 120.

In step S1304, the workflow platform 130 receives the login result from the print service 120. Thereafter, the workflow platform 130 can communicate with the print service 120 as having established cooperation.

In step S1305, the workflow platform 130 acquires the setting list of the present workflow action.

In step S1306, the workflow platform 130 displays the setting screen of the workflow action acquired in step S1305.

In step S1307, the workflow platform 130 saves the settings of the set redaction rule list acquisition action.

According to the steps of FIG. 15, the workflow platform 130 can incorporate the redaction rule list acquisition action into any workflow.

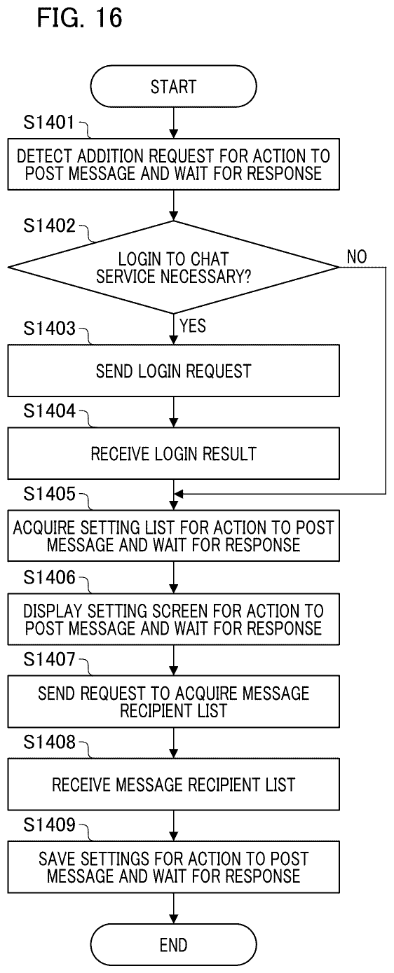

FIG. 16 is a flowchart showing details of constructing a workflow in cooperation with the chat service 140 in the workflow platform 130 in the present system. FIG. 16 is a flowchart of the workflow platform showing an example of processing of an action to post a message and wait for a response according to the First Embodiment, Second Embodiment, and Third Embodiment of the present invention.

In the Present Embodiment, as an example thereof, a process of posting a message on the chat screen of the chat service 140 and acquiring a response of a user to the message is constructed as a workflow action. Although the elements of the message posted by the action to post a message and wait for a response are not limited, these elements can be configured by components such as character strings, buttons, and dropdown lists.

In addition, in this action, the posted message is displayed on the screen of the chat application. The response that this action acquires is the posting of messages performed by users via the chat application, the detection of button presses, and the like.

In step S1401, the workflow platform 130 detects an addition request of the action to post a message and wait for a response.

In step S1402, the workflow platform 130 confirms whether cooperation with the chat service 140 that provides the action to post a message and wait for a response is already set, and determines whether login to the chat service 140 is necessary.

In a case in which the workflow platform 130 determines that login to the chat service 140 is necessary, the processing of step S1403 is executed. In a case in which the workflow platform 130 determines that login to the chat service 140 is not necessary, the processing of step S1405 is executed.

It should be noted that, as described above, the account of the chat service 140 may be the same as the account of the workflow platform 130, and in that case, login for cooperation is unnecessary.

In step S1403, the workflow platform 130 transmits a login request to the chat service 140.

In step S1404, the workflow platform 130 receives the login result from the chat service 140, and thereafter can communicate with the chat service 140 as having established cooperation with the chat service 140.

In step S1405, the workflow platform 130 acquires the setting list of the action to post a message and wait for a response.

In step S1406, the workflow platform 130 displays the setting screen of the action to post a message and wait for a response acquired in step S1405.

In step S1407, the workflow platform 130 transmits a request to acquire a list of message recipients to the chat service 140.

In step S1408, the workflow platform 130 receives a list of message recipients from the chat service 140. The settings for this action are the specification of the message poster and the user or group or channel of the chat service 140 to which the message is to be posted, the content of the message to be posted, the response deadline for the message, and the like.

These are examples, and it is not necessary to include all the items, or include other items. The content of the message is not limited to those composed of simple character strings alone, but may also be in card format described by JSON. JSON is an abbreviation for “JavaScript Object Notation”.

It should be noted that by displaying a list of redaction rules acquired by the above-described redaction rule list acquisition action as the message content, an action can be constructed that prompts the user to select any redaction rule. In step S1408, the workflow platform 130 may display the received list of message recipients.

In step S1409, the workflow platform 130 saves the settings of the action to post a message and wait for a response.

According to the steps of FIG. 16, the workflow platform 130 can incorporate into any workflow an action to send a message to the chat service 140 in cooperation with the chat service 140 and acquire a response from a user.

It should be noted that in the Present Embodiment, the process of posting a message to the chat service 140 and acquiring a response from a user to the message was constructed as a single action. The process of posting a message and the process of acquiring a response from a user may be divided into separate actions and incorporated into the workflow.

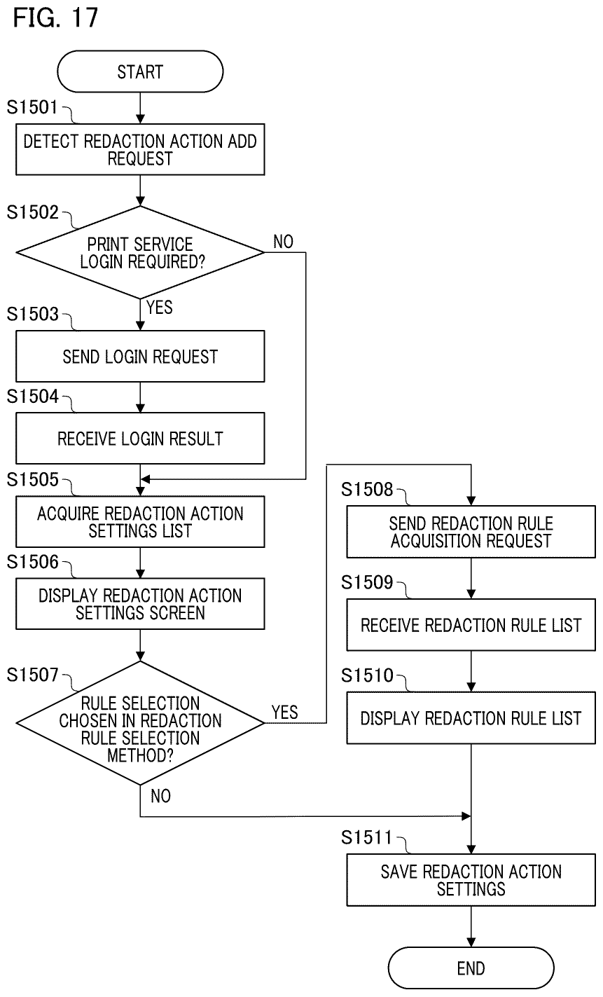

FIG. 17 is a flowchart of the print service 120 showing details of when performing the construction of a workflow in cooperation with the print service 120 in the workflow platform 130 in the present system.

FIG. 17 is a flowchart of the workflow platform showing an example of processing of a redaction action according to the First Embodiment, Second Embodiment, and Third Embodiment of the present invention.

In the Present Embodiment, as an example thereof, a redaction action is constructed as a workflow action that transmits scanned image file data to the print service 120, executes specified redaction processing, and receives the redacted image data.

In step S1501, the workflow platform 130 detects an addition request of the redaction action. Because the processing of steps S1502 to S1504 is processing to perform cooperation with the print service 120, and is similar to the processing in steps S1302 to S1304 in FIG. 15, an explanation thereof is omitted.

In step S1505, the workflow platform 130 acquires the setting list of the redaction action.

In step S1506, the workflow platform 130 displays the setting screen of the redaction action acquired in step S1505. In the redaction action, it is necessary to input the image data to which redaction processing is applied and to set the redaction locations within the image data.

In step S1507, the workflow platform 130 detects the selection state of the action setting 804 in the workflow action setting screen 800 in the redaction action, and determines whether or not redaction rule selection is chosen by the user.

In a case in which the workflow platform 130 determines that redaction rule selection has been chosen, the processing of step S1508 is executed. In a case in which the workflow platform 130 determines that redaction rule selection has not been chosen, the processing of step S1511 is executed.

In step S1508, the workflow platform 130 transmits an acquisition request of redaction rules to the print service 120.

In step S1509, the workflow platform 130 receives a list of predefined redaction rules from the print service 120.

In step S1510, the workflow platform 130 displays the list of predefined redaction rules in the action setting 805 within the workflow action setting screen 800 of the redaction action.

In contrast, in a case where the workflow platform 130 determines in step S1507 that redaction rule selection has not been selected, the processing is as follows. In this case, for example, if specifying by the identifier of the redaction rule acquired by a trigger or action executed earlier, the action setting 805 is displayed as a component capable of inputting the identifier, and the processing of step S1511 is performed.

This means that by using this in combination with the previously mentioned redaction rule list acquisition action and the action to post a message and acquire a response, a workflow can be constructed in which a user can select a redaction rule and execute redaction processing accordingly.

Here, the selection of a redaction rule by a user refers to the user being able to select any redaction rule from the redaction rules predefined in the print service 120 via the chat application.

In step S1511, the workflow platform 130 saves the settings of the redaction action.

According to the steps of FIG. 17, the workflow platform 130, in cooperation with the print service 120, can send image data to the print service 120 and incorporate a redaction action provided by the print service 120 into any workflow.

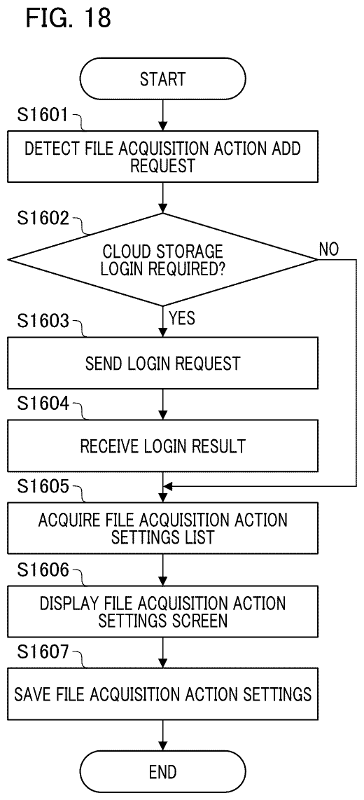

FIG. 18 is a flowchart of the workflow platform 130 showing details of when performing the construction of a workflow in cooperation with the cloud storage 150 in the workflow platform 130 in the present system.

FIG. 18 is a flowchart of the workflow platform showing an example of processing of a file creation action according to the First Embodiment, Second Embodiment, and Third Embodiment of the present invention.

In the Present Embodiment, as an example thereof, an action to create a file in a specified folder of the cloud storage 150 is constructed as an action of the workflow. The file creation action is an action to name specified image data and store the data as a file in a specified folder within the cloud storage 150.

In step S1601, the workflow platform 130 detects an addition request of the file creation action. Because the processing of steps S1602 to S1604 is processing to perform cooperation with the cloud storage 150, and is similar to the processing in steps S1102 to S1104 in FIG. 13, an explanation thereof is omitted.

In step S1605, the workflow platform 130 acquires the setting list of the file acquisition action.

In step S1606, the workflow platform 130 displays the setting screen of the file acquisition action acquired in step S1605.

In the file creation action, it is necessary to specify the site URL of the file creation destination, folder path, file name, and file contents. At this time, the file contents may be image data generated by an action executed earlier than the file creation action, and for example, a workflow is constructed by selecting the image data after redaction processing generated by the redaction action of FIG. 17.

In step S1607, the workflow platform 130 saves the settings of the set file acquisition action.

According to the steps of FIG. 18, the workflow platform 130 can incorporate the file creation action into any workflow.

By the steps of FIG. 12 to FIG. 18 described above, the workflow platform 130 can realize a workflow configuration procedure in which scanning by the printer 110 is selectable as an image data input unit.

Next, a flowchart for executing a workflow configured by the procedure explained in FIG. 12 to FIG. 18 will be explained. In the following, the operation when executing the following workflow is explained. In the following, a redaction rule is specified by scanning a document with the printer 110 and selecting a redaction rule according to a message posted in the chat application.

In addition, in the following, image data to which redaction processing has been applied based on the specified redaction rule is saved in the cloud storage 150. It should be noted that this workflow is merely an example, and the services combined and the order thereof are not limited thereto.

The workflow may be triggered by a file being saved in the cloud storage 150. The workflow may also be triggered by scanning being performed by the printer 110.

In addition, a list of constructed workflows of the workflow platform 130 may be displayed on the chat service 140, and workflows selected from the chat service 140 may be made executable. It should be noted that an example in which scanning by the printer 110 serves as a workflow trigger will be described in the Second Embodiment of the present invention.

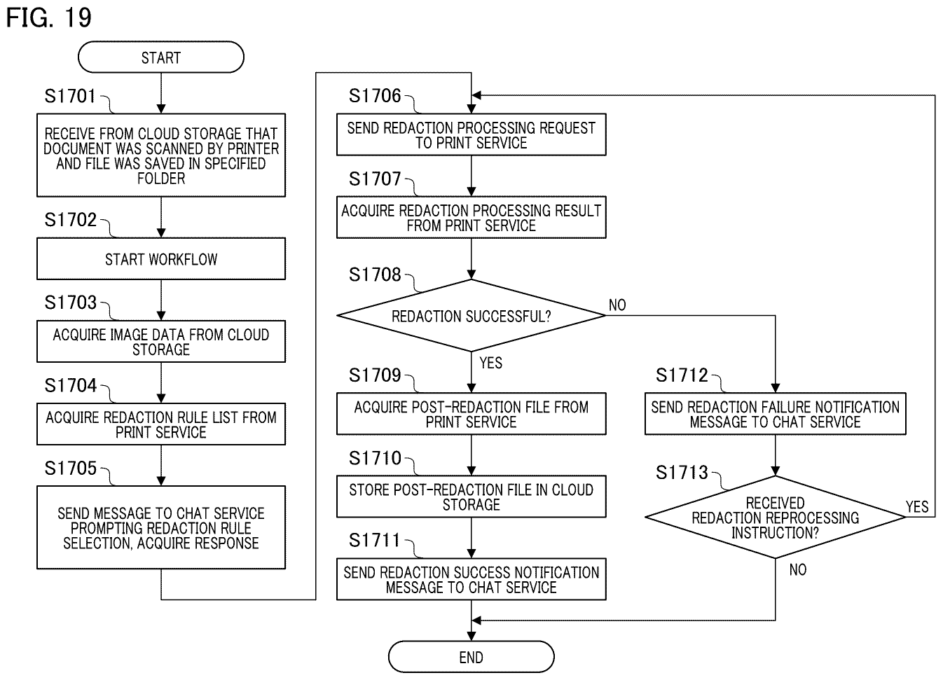

FIG. 19 is a flowchart showing the operation when executing the workflow in the workflow platform 130 in the present system. FIG. 19 is a flowchart of the workflow platform during workflow execution according to the First Embodiment of the present invention.

In the Present Embodiment, a profile created in the print service 120 by the procedure of FIG. 12 is selected on the display control unit 413 of the printer 110, and a document is scanned. When, as a result of this scanning, a scanned document is saved in a specified folder of the cloud storage 150, in step S1701, the workflow platform 130 receives a notification thereof from the cloud storage 150. The file is, for example, a document file for a document.

In step S1702, the workflow platform 130 starts the corresponding workflow by receiving the notification.

In step S1703, the workflow platform 130 acquires file information from the notification received in step S1701. The file information acquired here is, for example, the contents of the file itself, or the URL from which the file can be downloaded and the file name.

In step S1704, the workflow platform 130 acquires from the print service 120 a list of redaction rules defined in the print service 120.

In step S1704, the workflow platform 130 transmits a message to the chat service 140 that incorporates the redaction rules acquired in step S1704 in a format selectable by the user.

In addition, in step S1704, the workflow platform 130 acquires a response of a user that selects a redaction rule in the chat application. It should be noted that, as described in the explanation of FIG. 16, the transmission of a message prompting the selection of a redaction rule and the acquisition of a response of the user may be constructed as separate processes on the workflow.

In addition, the present invention is not limited to redaction rules already defined in the print service 120, and keywords such as “email address” may be acquired as redaction locations from the chat service 140.

In step S1706, the workflow platform 130 transmits the identifier of the redaction rule acquired from the chat service 140 in step S1705 and the file information of the redaction target acquired in S1703 to the print service 120. Accordingly, the workflow platform 130 requests the execution of redaction processing to the print service 120.

In step S1707, the workflow platform 130 receives the execution result of the redaction processing from the print service 120.

In step S1708, the workflow platform 130 determines whether or not the execution result of the redaction processing is successful or not. In a case in which the workflow platform 130 determines that the redaction processing is successful, the processing of step S1709 is executed. In a case in which the workflow platform 130 determines that the redaction processing is not successful, the processing of step S1712 is executed.

In step S1709, the workflow platform 130 acquires the file after redaction from the print service 120.

In step S1710, the workflow platform 130 saves the file after redaction in the specified folder of the cloud storage 150 by the file creation action set by the procedure of FIG. 18.

In step S1711, the workflow platform 130 transmits a redaction success notification to the chat service 140 and terminates the processing.

In step S1712, the workflow platform 130 transmits a redaction failure notification to the chat service 140. It should be noted that in the Present Embodiment, it is described that the workflow platform 130 is configured to determine the success or failure of the redaction processing result and perform notification through the chat service 140.

However, the print service 120 may perform similar processing instead of the workflow platform 130. In addition, in a case in which the notification of step S1712 is transmitted to the chat service by an action that is constructible by the procedure of FIG. 16, the user may be given the option to select whether or not to re-execute the redaction processing.

In step S1713, the workflow platform 130 determines whether or not a re-execution instruction of redaction processing has been received from the chat service 140. In a case in which the workflow platform 130 determines that a re-execution instruction has been received, the processing of step S1706 is executed. In a case in which the workflow platform 130 determines that a re-execution instruction has not been received, the processing is terminated.

It should be noted that in a case in which the redaction processing fails, an instruction to skip the redaction processing and store the scanned image data as is in the cloud storage 150 may be accepted from a message in the chat service 140. In that case, the flow is terminated by executing the processing of step S1710.

According to the steps of FIG. 19, the workflow platform 130 executes the workflow in cooperation with the print service 120, the cloud storage 150, and the chat service 140. In addition, according to the procedure of FIG. 19, the workflow platform 130 can execute redaction processing on scanned documents and store redacted files in a predetermined storage.

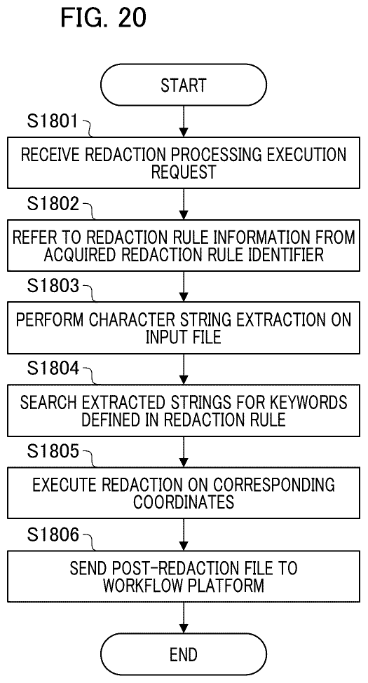

FIG. 20 is a flowchart of the print service 120 showing the operation when executing the above-described workflow in the workflow platform 130 in the present system. FIG. 20 is a flowchart showing an example of redaction processing of the print service during workflow execution according to the First Embodiment of the present invention.

In the Present Embodiment, as an example of a redaction rule, a process is explained in which the print service 120 detects character strings related to email addresses in a scanned document and redacts the coordinates corresponding to these detected character strings.

In step S1801, the print service 120 receives an execution request of redaction processing from the workflow platform 130. At this time, the print service 120 acquires an identifier of the redaction rule and a file of the scan document on which redaction processing is to be performed from the workflow platform 130.

In step S1802, the print service 120 refers to the corresponding predefined redaction rule from the identifier of the redaction rule acquired in step S1801.

In step S1803, the print service 120 performs character string extraction processing by OCR processing on the file of the scan document received from the workflow platform 130 in step S1801.

In step S1804, the print service 120 searches for character strings corresponding to keywords of the selected redaction rule from the character strings extracted in step S1803. For example, in a case in which “email address” is specified as a keyword for redaction locations, locations matching the format of an email address such as “XXXX@XXX.co.jp” are searched for from character strings in the document. This is an example in the Present Embodiment, and the present invention does not limit search locations thereto.

In step S1805, the print service 120 executes redaction processing on the corresponding character strings in the file.

In step S1806, the print service 120 transmits the file after redaction processing to the workflow platform 130 and terminates the processing.

According to the steps of FIG. 20, the print service 120 can perform redaction processing on the received file. It should be noted that although character strings were extracted from the file in step S1803 and character strings were searched for according to keywords defined in the redaction rule from the extracted character strings in step S1804, the unit that selects redaction locations is not limited thereto. For example, redaction locations may be specified in advance by coordinates in the image data.

As described above, according to the Present Embodiment, the workflow platform 130 can construct a workflow system that incorporates scanning by the printer 110 as a constituent element of an image data input unit by cooperating with a plurality of services and the print service 120.

It should be noted that, although redaction processing was explained as an example of a processing unit for input image data in the Present Embodiment, the constructible workflow processing is not limited thereto. For example, the workflow processing may be image processing such as masking processing, stamping processing, file format conversion, file merging, or the workflow processing may be constructed in combination with actions that are not image processing such as approval and notification. In addition, a plurality of these may be combined, or a workflow system may be constructed without including these.

### Second Embodiment

In the First Embodiment, a workflow constructed on the workflow platform 130 was started by selecting a profile constructed in the print service 120 on the printer 110 and scanning, whereby scan image data was stored in the cloud storage 150.

Furthermore, an example was shown in which a file was stored in the cloud storage 150 after redaction processing was performed. In a Second Embodiment, a workflow system is provided in which scanning by the printer 110 is selectable as a trigger or action of the workflow platform 130.

First, a procedure for constructing a workflow on the workflow platform 130 in the Present Embodiment will be explained. Explanations of the workflow list screen 500, workflow editing screen 600, and workflow editing screen 700 are omitted here because they are similar to FIG. 7 to FIG. 9 in the First Embodiment. Here, the procedure for actually connecting to each service and setting configurations to construct a workflow will be explained with respective flowcharts.

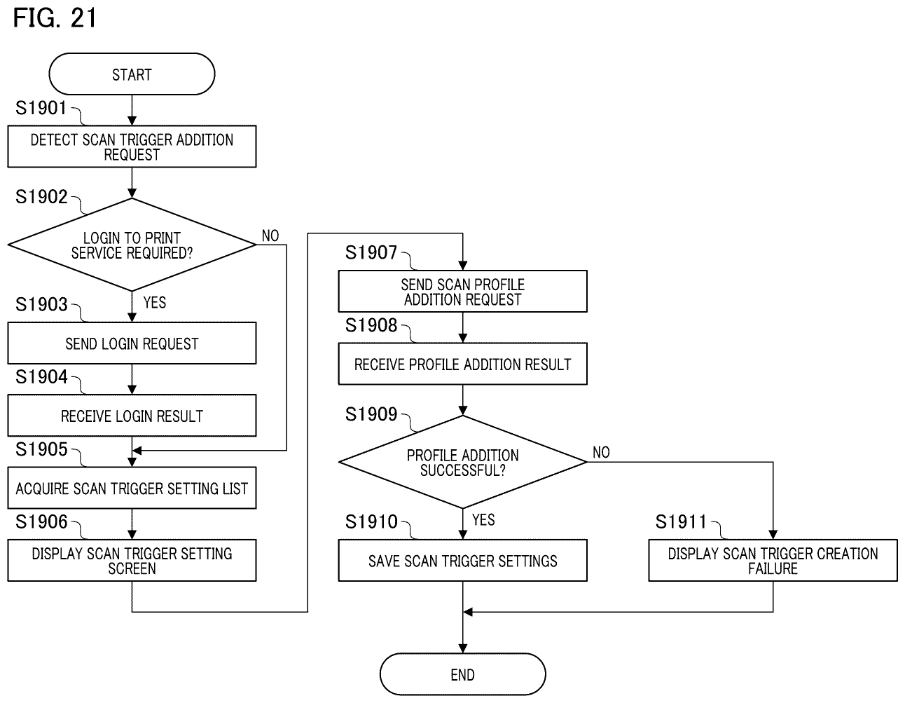

FIG. 21 is a flowchart showing details of processing to perform the construction of a workflow in cooperation with the print service 120 in the workflow platform 130 in the present system. FIG. 21 is a flowchart of the workflow platform showing an example of processing of a scan trigger according to the Second Embodiment of the present invention.

In the Present Embodiment, as an example thereof, a scan trigger that starts a workflow by scanning a document with the printer 110 connected to the print service 120 is constructed as a trigger of the workflow.

In step S1901, the workflow platform 130 detects an addition request of the scan trigger.

In step S1902, the workflow platform 130 confirms whether cooperation with the print service 120 that provides the scan trigger is already set, and determines whether or not login to the print service 120 is necessary.

In a case in which the workflow platform 130 determines that login to the print service 120 is necessary, the processing of step S1903 is executed. In a case in which the workflow platform 130 determines that login to the print service 120 is not necessary, the processing of step S1905 is executed.

In step S1903, the workflow platform 130 transmits a login request to the print service 120.

In step S1904, the workflow platform 130 receives the login result from the print service 120, and thereafter can communicate with the print service 120 as having established cooperation with the print service 120.

In step S1905, the workflow platform 130 acquires the setting list of the scan trigger.

In step S1906, the workflow platform 130 displays the setting screen of the scan trigger acquired in step S1905. In the scan trigger, for example, scan profile name, file naming rule, color setting at scan execution, duplex setting, and file format are displayed. It should be noted that these setting items are examples, and settings related to OCR processing and the like may be included.

In step S1907, the workflow platform 130 transmits a profile addition request to the print service 120 based on the setting information of the scan trigger input by the user.

In step S1908, the workflow platform 130 receives the profile addition result from the print service 120. At this time, in a case in which the print service 120 has succeeded in profile addition, an identifier for tracking the added profile is also received.

In step S1909, the workflow platform 130 determines whether or not the print service 120 has succeeded in profile addition based on the reception result in step S1908. In a case in which the workflow platform 130 determines that the addition is successful, the processing of step S1910 is executed. In a case in which the workflow platform 130 determines that the addition is not successful, the processing of step S1911 is executed.

In step S1910, the workflow platform 130 saves the settings of the scan trigger.

In step S1910, the workflow platform 130 displays on the workflow editing screen 600 that the creation of the scan trigger has failed.

According to the steps of FIG. 21, the workflow platform 130, in cooperation with the print service 120, can incorporate into any workflow a scan executed by selecting an added profile on the printer 110 as a trigger.

It should be noted that the scan trigger provides the acquisition of metadata related to the created scan image data, such as the name or identifier of the created scan image data, to workflow actions implemented thereafter.

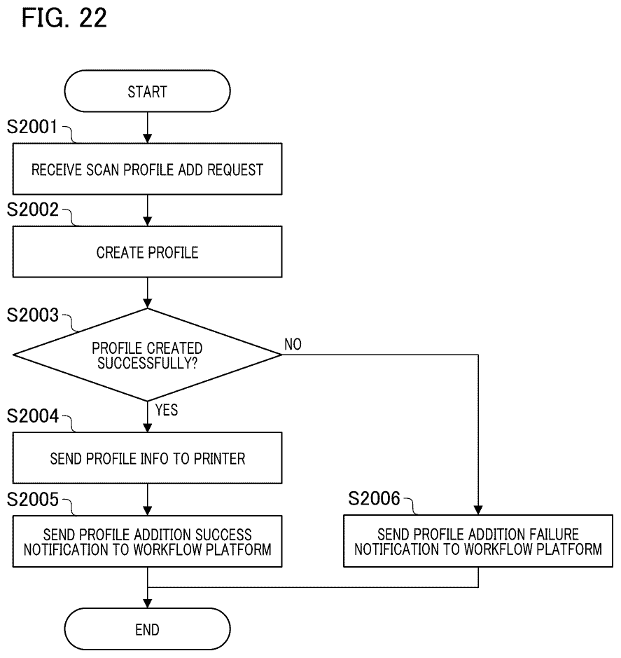

FIG. 22 is a flowchart describing details of processing to add a profile indicating the definition of scan processing in response to a request from the workflow platform 130 in the print service 120 in the present system.

FIG. 22 is a flowchart of the workflow platform showing an example of processing of a profile addition request to the print service according to the Second Embodiment of the present invention

In the Present Embodiment, as an example thereof, the print service 120 publishes an API for accepting profile addition requests from external sources. The workflow platform 130 realizes profile addition in the print service 120 linked with the construction of the workflow by calling this published API of the print service. API is an abbreviation for “Application Programming Interface”.

In step S2001, the print service 120 receives a profile addition request. The command received by the print service 120 is the API published by the print service 120, and this API includes the information necessary for profile addition.

At this time, the information necessary for profile addition is, for example, scan profile name, file naming rule, color setting at scan execution, duplex setting, file format, and the like.

In step S2002, the print service 120 adds the profile based on the information received in step S2001. The added profile is managed by the profile management unit 426.

In step S2003, the print service 120 determines whether or not the profile addition has been completed successfully by the processing of step S2002. In a case in which the print service 120 determines that the profile addition has been completed successfully, the processing of step S2004 is executed. In a case in which the print service 120 determines that the profile addition has not been completed successfully, the processing of step S2006 is executed.

In step S2004, the print service 120 transmits information of the added profile to the printer.

In step S2005, the print service 120 returns a response indicating that profile addition has succeeded to the workflow platform 130 and terminates the processing. This response includes an identifier of the profile necessary for the workflow platform 130 to identify the added profile.

It should be noted that in the Present Embodiment, although the print service 120 returned a response to the workflow platform 130 after transmitting profile information to the printer 110, the timing of transmitting profile information to the printer 110 is not limited thereto.

For example, the print service 120 may transmit the result to the workflow platform 130 when profile addition is completed, and may periodically transmit profile information to the printer 110 after the steps of FIG. 22.

In step S2006, the print service 120 returns a response indicating that profile addition has failed to the workflow platform 130 and terminates the processing.

According to the steps of FIG. 22, the print service 120 can add profiles in response to commands received from external sources. In addition, the workflow platform 130 incorporates the transmission processing of this command into the construction process of triggers and actions. Thereby, profiles can be added to the print service 120 in cooperation with the creation of triggers and actions, and the execution of scans using these profiles can be made trackable.

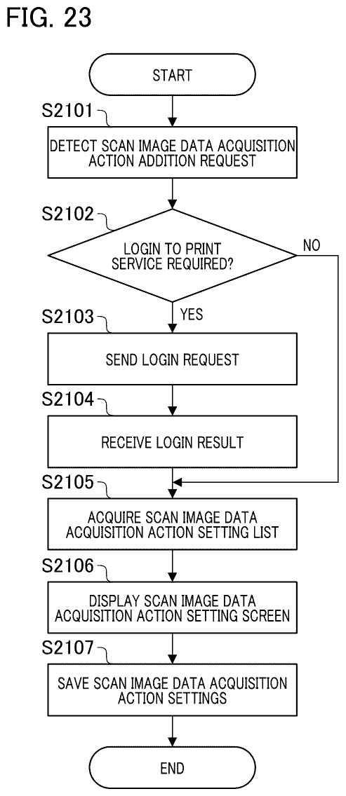

FIG. 23 is a flowchart showing details when performing the construction of a workflow in cooperation with the print service 120 in the workflow platform 130 in the present system. FIG. 23 is a flowchart of the workflow platform showing an example of processing of a scan image data acquisition action according to the Second Embodiment of the present invention.

In the Present Embodiment, as an example thereof, a scan image data acquisition action that acquires image data generated by scanning with the printer 110 is constructed as an action of the workflow. The scan image data acquisition action is an action to acquire the content of specified scan-generated image data, a publicly available URL, or a limited-access URL.

In step S2101, the workflow platform 130 detects an addition request of the scan image data acquisition action.

The workflow platform 130 executes cooperation processing with the print service 120 that provides the scan image data acquisition action by the processing of steps S2102 to S2104. Because these steps S2102 to S2104 are similar to the processing in steps S1902 to S1904 in FIG. 21, a detailed explanation thereof is omitted.

In step S2105, the workflow platform 130 acquires the setting list of the scan image data acquisition action.

In step S2106, the workflow platform 130 displays the setting screen of the scan image data acquisition action acquired in step S2105. In the scan image data acquisition action, it is necessary to specify the file to be acquired. For example, an identifier of the scan image data that can be acquired from the scan trigger of FIG. 21 is specified here.

In step S2107, the workflow platform 130 saves the settings of the set scan image data acquisition action (step S2107).

According to the steps of FIG. 23, the workflow platform 130 can incorporate the scan image data acquisition action into any workflow. In the Present Embodiment, by specifying the identifier of scan image data acquired by the scan trigger explained in FIG. 21 as an element of this action, a workflow capable of acquiring scan image data can be constructed.

It should be noted that scan image data may be acquired even in workflows in which a scan trigger does not exist. In that case, in addition to the items in the settings of the present action, setting items of the scan trigger such as scan profile name, file naming rule, color setting at scan execution, duplex setting, and file format are saved. By saving these items, an action that waits for scanning by the printer 110 and acquires scan image data can be constructed.

As described above, according to the steps of FIG. 21 to FIG. 23, the workflow platform 130 can realize a workflow configuration process in which scanning by the printer 110 is selectable as an image data input unit.

Next, a flowchart for executing a workflow configured by the steps explained in FIG. 15 to FIG. 18, and FIG. 21 to FIG. 23 will be explained. In the Present Embodiment, the operation when executing a workflow similar to the First Embodiment will be explained.

In the following, a redaction rule is specified by scanning a document with the printer 110 and selecting a redaction rule according to a message posted in the chat application. In addition, in the following, image data to which redaction processing has been applied based on the specified redaction rule is saved in the cloud storage 150.

In the First Embodiment, although the trigger was the storage of scan image data in the cloud storage, in the Present Embodiment, the workflow starts with the scan operation on the printer 110 as the trigger. It should be noted that this embodiment is merely an example, and the services to be combined and the order thereof are not limited thereto.

FIG. 22 is a flowchart showing the operation when executing the above-described workflow in the workflow platform 130 in the present system. FIG. 22 is a flowchart of the workflow platform showing an example of processing of a profile addition request to the print service according to the Second Embodiment of the present invention.

In step S2201, the workflow platform 130 receives from the print service 120 that a document has been scanned by using the specified profile on the printer 110. At this time, the workflow platform 130 also acquires an identifier for specifying the scan image data from the print service 120.

In step S2202, the workflow platform 130 starts the corresponding workflow upon receiving the notification.

In step S2203, the workflow platform 130 acquires the scan image data from the print service based on the identifier of the scan image data received in step S2201.

Thereafter, in the processing of steps S2204 to S2213, acquisition of redaction processing rules provided by the print service 120, acceptance of redaction rule specification via the chat service 140, redaction processing, and storage of the file after redaction in the cloud storage 150 are performed. Because these processes are similar to steps S1704 to S1713 in FIG. 19, an explanation thereof is omitted here.

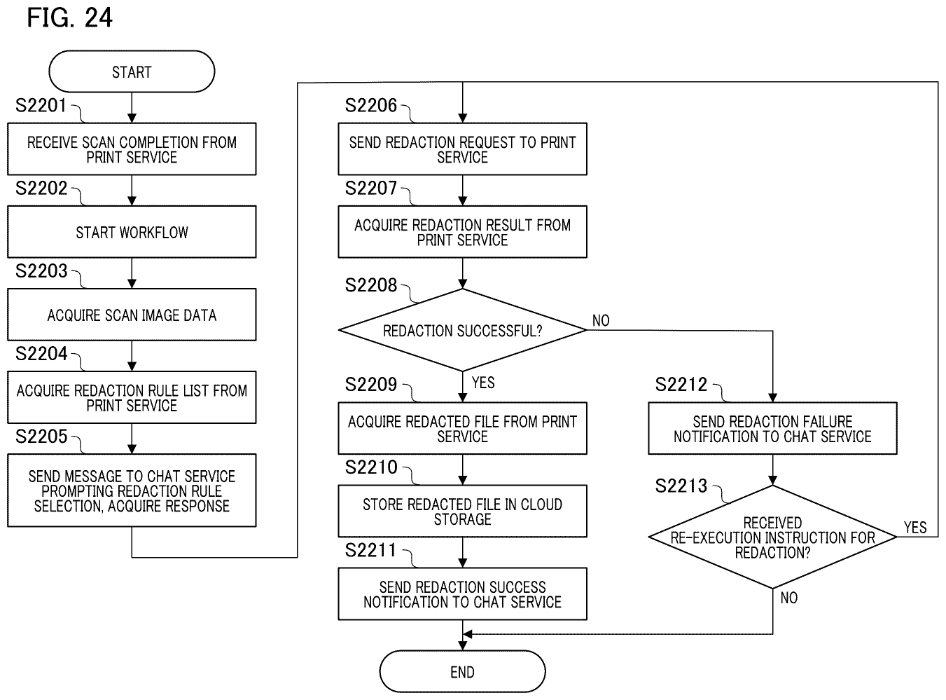

According to the steps of FIG. 24, the workflow platform 130 can execute a workflow triggered by scan execution on the printer 110 in cooperation with the print service 120, the chat service 140, and the cloud storage 150.

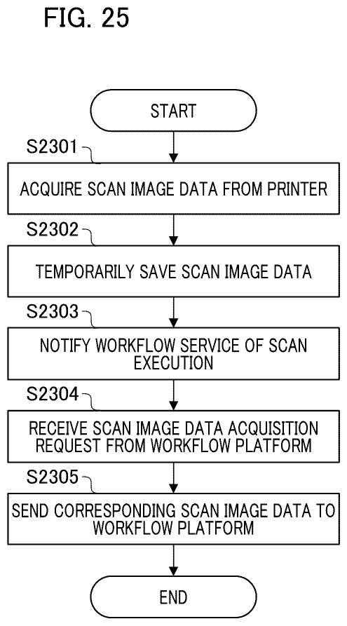

FIG. 25 is a flowchart of the print service 120 showing the operation related to scan processing when executing the above-described workflow in the workflow platform 130 in the present system. FIG. 25 is a flowchart showing an example of scan processing of the print service during workflow execution according to the Second Embodiment of the present invention.

In step S2301, when scanning of a document is executed by using the profile added by the procedure of FIG. 22 on the printer 110, the print service 120 receives scan image data from the printer 110.

In step S2302, the print service 120 temporarily saves the scan image data received in step S2301 in the job management unit 425 of the print service 120. At this time, an identifier for specifying the scan image data is issued, and this identifier is managed along with the scan image data.

In step S2303, the print service 120 transmits a notification indicating that scanning has been executed on the printer 110 to the workflow platform 130. By executing these processes, the scan trigger constructed on the workflow platform 130 is fired.

In step S2304, the print service 120 receives a request to acquire scan image data from the workflow platform 130.

In step S2305, the print service 120 transmits the scan image data to the workflow platform 130 in response to the acquisition request received in step S2304. At this time, the request received from the workflow platform 130 includes an identifier of the scan image data, and in step S2305, the corresponding image data, a publicly available URL of the file, or a limited-access URL is transmitted.

As described above, according to the Present Embodiment, the workflow platform 130 can start a workflow by scan execution and acquire scan image data via the print service 120.

### Third Embodiment

In the Present Embodiment, the workflow platform 130 provides a workflow construction unit in the workflow platform 130 in which the posting of image data to a chat application by a user is selectable as a workflow trigger.

First, the steps for constructing a workflow on the workflow platform 130 in the Present Embodiment will be explained. Explanations of the workflow list screen 500, the workflow editing screen 600, and the workflow editing screen 700 are omitted here as they are similar to the explanations in FIGS. 7 to 9 in the First Embodiment. Here, the procedure for actually connecting to each service and configuring settings to construct a workflow will be explained with respective flowcharts.

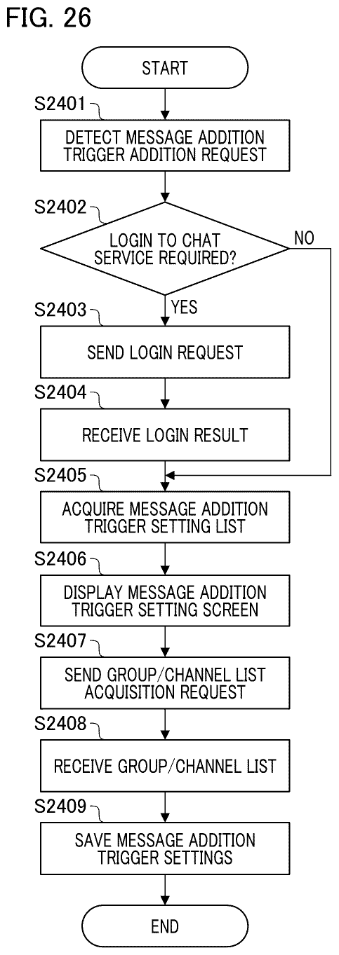

FIG. 26 is a flowchart of the workflow platform 130 showing details when performing the construction of a workflow in cooperation with the chat service 140 in the workflow platform 130 in the present system.

In the Present Embodiment, as an example thereof, a message addition trigger is constructed as a trigger of the workflow that is triggered when a message is added to the chat service 140 via the chat application by a user.

In step S2401, the workflow platform 130 detects an addition request of the message addition trigger.

The workflow platform 130 executes cooperation processing with the chat service 140 that provides the message addition trigger in steps S2402 to S2404. Because these processes are similar to the processing of steps S1402 to S1404 in FIG. 16, an explanation thereof is omitted here.

In step S2405, the workflow platform 130 acquires the setting list of the message addition trigger.

In step S2406, the workflow platform 130 displays the setting screen of the message addition trigger acquired in step S2405. In the message addition trigger, setting items to specify groups or channels to monitor for message posting by users are displayed.

In step S2407, the workflow platform 130 transmits an acquisition request of a group/channel list that can be monitored for message addition in the chat service 140.

In step S2408, the workflow platform 130 receives a list of groups/channels from the chat service 140.

In step S2409, the workflow platform 130 saves the settings of the message addition trigger.

According to the steps of FIG. 24, the workflow platform 130, in cooperation with the chat service 140, can incorporate into any workflow a trigger that starts a workflow when a message is added in the chat service 140.

It should be noted that the workflow platform 130 manages the information of the message acquired by the execution of this trigger. In addition, the workflow platform 130 provides the acquisition of information related to the message, such as the text configuring the message and identifiers of attached files, to workflow actions implemented after this trigger.

As described above, according to the steps of FIG. 14 and FIG. 26, the workflow platform 130 can realize a workflow configuration process in which the posting of image data in a chat application can be selected to serve as an image data input unit in the workflow.

Next, a flowchart for executing a workflow configured by the procedures explained in FIG. 13 to FIG. 18 and FIG. 26 will be explained. In the Present Embodiment, a document file posted by a user to the chat application is acquired, a redaction rule selected by the user in the chat application is acquired, and redaction processing is applied based on that redaction rule.

Then, the operation when executing a workflow that saves the image data after redaction processing to the cloud storage 150 is shown. The Present Embodiment is merely an example, and the services to combined and the order thereof are not limited thereto.

It should be noted that in the Present Embodiment, an example is shown in which files attached to messages posted to the chat service 140 are managed by the cloud storage 150 that is cooperating with the chat service 140. The present invention may also have the chat service 140 itself manage the posted files.

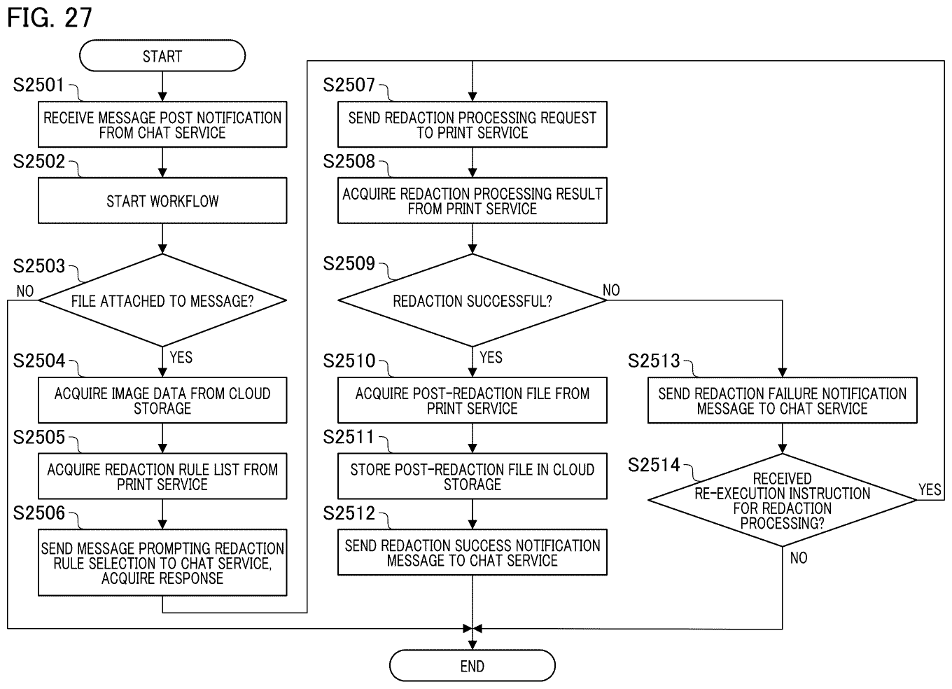

FIG. 27 is a flowchart showing the operation when executing the above-described workflow in the workflow platform 130 in the present system. FIG. 27 is a flowchart of the workflow platform during workflow execution according to the Third Embodiment of the present invention.

In step S2501, the workflow platform 130 receives notification from the chat service 140 that a document file has been posted to the chat service 140 by a user. At this time, the workflow platform 130 also acquires information with respect to the posted message from the chat service 140.

In step S2502, the workflow platform 130 starts the corresponding workflow by the message addition trigger created by the steps of FIG. 26 by receiving the notification.

In step S2503, the workflow platform 130 determines whether or not a file (image data) is attached to the message based on the message information acquired in step S2501. In a case in which the workflow platform 130 determines that a file is attached to the message, the processing of step S2504 is executed. In a case in which the workflow platform 130 determines that a file is not attached to the message, the processing is terminated.

In step S2504, the workflow platform 130 acquires the attached file of the message posted to the chat service 140 by the file acquisition action created by the procedure of FIG. 14. This can be constructed by specifying the message information generated by the message addition trigger in the setting items of the file acquisition action mentioned in FIG. 14.

After acquiring the document file by the processing of step S2504, the processing of steps S2505 to S2514 thereafter executes processing similar to steps S1704 to S1713 of FIG. 19. Thereby, acquisition of redaction processing rules provided by the print service 120, acceptance of redaction rule specification via the chat service 140, redaction processing, and storage of the file after redaction in the cloud storage 150 are realized.

According to the steps of FIG. 25, the workflow platform 130 cooperates with the print service 120, the chat service 140, and the cloud storage 150. Furthermore, the workflow platform 130 provides the realization of a workflow system that uses file posting in the chat service 140 serving as an image data input unit.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the workflow system and the like through a network or various storage media. Then, a computer (or a CPU, an MPU, or the like) of the workflow system and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-173214, filed on Oct. 4, 2023, which is hereby incorporated by reference herein in its entirety.

What is claimed is:

1. A workflow system configured to execute a workflow, the workflow system comprising:
a workflow platform that is a service configured to enable a user to construct a workflow;
a chat service that is a service configured to accept input from a user and perform notifications to a user;
wherein the workflow platform comprises at least one processor or circuit configured to function as:
a workflow construction unit configured to construct a workflow in cooperation with the chat service; and
a workflow execution unit configured to execute a workflow constructed by the workflow construction unit;
wherein the workflow construction unit is configured to be capable of constructing a workflow using input accepted by the chat service.

2. The workflow system according to claim 1, further comprising:
a print service that is a service configured to manage an image processing apparatus comprising an image scanning function and to receive image data scanned by the image processing apparatus,
wherein the workflow construction unit is configured to construct a workflow in cooperation with the print service and is configured to be capable of constructing a workflow using image data scanned by the image processing apparatus in the print service.

3. The workflow system according to claim 2, wherein the workflow construction unit further comprises a function to request the print service to add a profile related to scanning by the image processing apparatus.

4. The workflow system according to claim 2, wherein the workflow execution unit further comprises a function to start a workflow by a scanning operation of the image processing apparatus.

5. The workflow system according to claim 2, wherein the workflow execution unit further comprises a function to acquire from the print service image data scanned by the image processing apparatus.

6. The workflow system according to claim 2, wherein the workflow execution unit further comprises a function to acquire a list of rules defined for operation of functions provided by the print service.

7. The workflow system according to claim 2, wherein the workflow execution unit further comprises a function to accept, via the chat service, selection of a rule defined for operation of functions provided by the print service.

8. The workflow system according to claim 7, wherein the workflow execution unit further comprises a function to modify processing of the workflow according to the rule selected and accepted via the chat service.

9. The workflow system according to claim 1, wherein the workflow execution unit further comprises a function to detect that a message has been posted to the chat service.

10. The workflow system according to claim 9, wherein the workflow execution unit further comprises a function to specify any channel that monitors message posts to the chat service.

11. The workflow system according to claim 9, wherein the workflow execution unit further comprises a function to start a workflow by a message being posted to the chat service.

12. The workflow system according to claim 9, wherein the workflow execution unit further comprises a function to determine whether image data is attached to a message posted to the chat service.

13. The workflow system according to claim 9, wherein the workflow execution unit further comprises a function to acquire image data attached to a message posted to the chat service.

14. The workflow system according to claim 1,
wherein the workflow construction unit is configured to construct a workflow in response to input to the chat service; and
wherein the workflow execution unit is configured to execute the workflow constructed by the workflow construction unit in response to input to the chat service.

15. The workflow system according to claim 2, further comprising cloud storage capable of saving files, wherein the workflow construction unit is capable of constructing a workflow in cooperation with the cloud storage, and
wherein the print service further comprises a function to create a profile for storing image data in the cloud storage.

16. The workflow system according to claim 2, further comprising cloud storage capable of saving files,
wherein the workflow construction unit is capable of constructing a workflow in cooperation with the cloud storage, and
wherein the workflow execution unit further comprises a function to start the workflow by the transmission to the cloud storage of image data generated by scanning on the image processing apparatus.

17. A method for controlling a workflow system comprising a workflow platform that is a service configured to enable a user to construct a workflow, and a chat service that is a service configured to accept input from a user and perform notifications to a user, wherein:
the workflow platform comprises workflow constructing that constructs a workflow in cooperation with the chat service, and workflow executing that executes a workflow constructed by the workflow constructing;
wherein the workflow constructing is capable of constructing a workflow using input accepted by the chat service.
